(19) United States
(12) Patent Application Publication
(10) Pub. No.: US 2011/0211601 A1
(43) Pub. Date: Sep. 1, 2011

(54) DRIVER LASER FOR EXTREME ULTRA VIOLET LIGHT SOURCE DEVICE

(76) Inventors: Tatsuya ARIGA, Hiratsuka-shi (JP); Hideo HOSHINO, Hiratsuka-shi (JP); Taisuke MIURA, Hiratsuka-shi (JP); Akira ENDO, Tokyo (JP)

(21) Appl. No.: 13/049,374

(22) Filed: Mar. 16, 2011

Related U.S. Application Data
(63) Continuation of application No. 11/892,792, filed on Aug. 27, 2007, now abandoned.

(30) Foreign Application Priority Data
Aug. 29, 2006 (JP) 2006-231589
Mar. 29, 2007 (JP) 2007-089367

(51) Int. Cl. H01S 3/10

(52) U.S. Cl. 372/27

(57) ABSTRACT

A driver laser for an extreme ultra violet light source device capable of suppressing self-oscillation light, amplifying a laser beam efficiently, and reducing a device size. The driver laser has an oscillator for generating a laser beam to output the generated laser beam, and at least one amplifier for amplifying the laser beam output from the oscillator to output the amplified laser beam. The amplifier includes a discharge unit which amplifies the laser beam by using energy of a laser medium excited by discharge, a feedback mirror which leads the laser beam output from the discharge unit to the discharge unit, a polarizer which leads the laser beam output from the oscillator into the discharge unit and also reflects the laser beam output from the discharge unit to a predetermined direction, and a self-oscillation light filter which attenuates self-oscillation light output from the discharge unit.

This application is a continuation of application Ser. No. 11/892,792, filed Aug. 27, 2007.

### BACKGROUND OF THE INVENTION

1. Field of the Invention

The present invention relates to a driver laser for irradiating a target with light in an LPP (laser produced plasma) type EUV (extreme ultra violet) light source device that generates extreme ultra violet light to be used for exposing a semiconductor wafer or the like.

2. Description of a Related Art

Recently, as semiconductor processes become finer, photolithography has been making a rapid progress to realize a higher resolution, and for the next generation, micro-fabrication of 100 nm to 70 nm, and further, micro-fabrication of 50 nm or less is being required. Accordingly, in order to meet the requirement of micro-fabrication of 50 nm or less, for example, exposure equipment is expected to be developed by combining an EUV light source generating extreme ultra violet light with a wavelength of approximately 13 nm and reduced projection reflective optics.

In such an EUV light source device, generally, a short pulse laser is used for a driving light source (driver), since a short pulse laser is suitable for obtaining high CE (conversion efficiency: efficiency in conversion from an irradiated laser beam to EUV light) in an LPP type EUV light source device.

FIG. 33 is a schematic diagram showing a constitution of an oscillation amplification type laser used for the driver. An oscillation amplification type laser 10, shown in FIG. 33, includes an oscillator 11 constituted by a short pulse CO₂ laser and an amplifier 12 for amplifying a laser beam generated by the short pulse CO₂ laser. Here, when the amplifier 12 does not have an optical resonator, a laser system with such a constitution is called as a MOPA (master oscillator power amplifier) system. The amplifier 12 has a discharge device that excites by discharge a CO₂ laser gas containing carbon dioxide (CO₂), nitrogen (N₂), helium (He), and further if needed, hydrogen (H₂), carbon monoxide (CO), xenon (Xe), etc.

Here, in the case where a resonator is provided in an amplification stage, different from the amplifier 12 shown in FIG. 33, laser oscillation may be possible by a single amplification stage. A laser system with such a constitution is called as a MOPO (master oscillator power oscillator) system.

A laser beam having energy A output from the oscillator 11 is amplified in the amplifier 12 into a laser beam having desired energy B. This laser beam having energy B is collected through a laser beam propagation system or lenses, and irradiated to an EUV light emission target material selected from among tin (Sn), xenon (Xe), etc.

Here, although only a single stage of an amplifier is provided for amplifying laser energy A to laser energy B in FIG. 33, a plurality of stages of amplifiers may be used in the case where desired laser energy B is not obtained.

Next, a constitutional example of a short pulse CO₂ laser as an oscillator will be described. U.S. Pat. No. 6,697,408 B2 discloses a constitution of a short pulse RF (Radio Frequency-excited) CO₂ laser (FIG. 5 of U.S. Pat. No. 6,697,408 B2). In this RF-CO₂ laser, a highly repeatable laser pulse operation is possible at a frequency up to about 100 kHz. In a practical case, since EUV light emission of 100 W class is required, an output required for a CO₂ laser becomes about 60 kW, assuming that CE of CO₂ laser is 0.5% and propagation loss is 70%. In order to achieve an output of 60 kW in a short pulse laser, a repetition frequency of about 50 kHz to 100 kHz is required, considering such as durability of optical elements or the like. Note that a pulse width of a laser beam output from an oscillator is preferably not more than 100 ns.

The reason is as follows. Denoting an output of CO₂ laser by Eₜₒₜₐₗ a pulse repletion frequency by fᵢ (i=1, 2, 3, etc.), and light energy of one pulse by Eₚⱼ=1, 2, 3, etc.) there is a relationship Eₜₒₜₐₗ=f₁×Eₚ₁=f₂×Eₚ₂ Here, when Eₚ is larger, damage provided to optical elements through which laser beam passes, becomes larger, and the optical elements deteriorate faster. Thus, smaller Eₚ is desirable. Therefore, a repetition frequency f may be increased for obtaining desired Eₜₒₜₐₗ while decreasing Eₚ.

For realizing such a high repetition frequency, it is preferable to use an RF (Radio Frequency-excited) CO₂ laser. The reason is that pulse CO₂ lasers include otherwise a TEA (Transverse Excitation Atmospheric) CO₂ laser, but repetition operation thereof is limited up to about 2 kHz in a state of the art. Referring to FIG. 5 of U.S. Pat. No. 6,697,408 B2, this laser device includes a multi-pass waveguide laser oscillator 400 and a multi-pass waveguide laser amplifier 400a. A resonator of the oscillator 400 is formed by total reflection mirrors 408 and 406. A Q-switch, an RF discharge unit, and a thin film polarizer (TFP) are provided between these mirrors. When the Q-switch is off, a laser beam travels back and forth between the mirror 408 and the mirror 406, and increases light intensity thereof by stimulated emission during the travel. When the Q switch is turned on in a state where the light intensity has been increased sufficiently, a short pulse with a sharp peak is reflected by the TFP 404 and guided into the multi-pass waveguide laser amplifier 400a shown in a lower part of FIG. 5 via the mirror 409 and the λ/4 wave plate. Then, the guided light is amplified in an amplifier and a laser beam is emitted to outside. A laser having such a constitution is called a Q-switch cavity-dumped laser.

By the way, it is known that a self oscillation or parasitic oscillation (hereinafter, referred to as simply “self oscillation”) occurs in an amplifier in such a case where a gain of an amplifier in an oscillation amplification type laser is high. Such a self oscillation may occur not only in an amplifier having a resonator in a MOPO system but also in an amplifier not having a resonator in a MOPA system.

For absorbing self-oscillation light caused by a self-oscillation, there is known a technology to provide an amplification stage with a saturable absorber that is a material absorbing a laser beam with lower intensity and transmitting a laser beam with higher intensity. Refer to, for example, P. Woskoboinikow et al. “Saturable gas absorber for a 9-μm-band CO₂-laser amplifier”, Optics Letters, July 1979, Vol. 4, No. 7, pp. 199-201.

In order to generate plasma in semiconductor exposure equipment, it is necessary to supply a laser beam having energy of about 30 mJ to 100 mJ at a repetition frequency of about 50 kHz to 100 kHz, considering various conditions of CE, propagation loss, etc. For realizing such a high repetition frequency, it is necessary to use an RF—CO₂ laser for an oscillator as described hereinabove. In a state of the art, however, a laser beam energy output from an RF—CO₂ laser is no more than about 1 mJ. Therefore, a laser beam energy output from an oscillator needs to be amplified about 30 to 100 times at an amplification stage.

FIGS. 34A and 34B are diagrams showing examples of amplification characteristics of amplifiers. As shown in FIGS. 34A and 34B, amplification characteristics of an amplifier include an amplification range and an amplification saturation range. The amplification range is a range in input laser beam energy where energy supplied to an amplifier from an external circuit (RF power source or the like) can be transmitted to an input laser beam with good efficiency and the input laser beam can be amplified with good efficiency. The amplification saturation range is a range in input laser beam energy where energy supplied to an amplifier from an external circuit (RF power source or the like) reaches a limit to be transmitted to an input laser beam and the input laser beam is no more amplified with good efficiency. Energy supplied to an amplifier from an external circuit (RF power source or the like) can be transmitted to an input laser beam with the best efficiency and the input laser beam can be amplified with the best efficiency in the case where energy of the input laser beam corresponds to the maximum value within the amplification range.

Accordingly, in order to amplify a laser beam output from an RF—CO₂ laser most efficiently about 30 to 100 times, it is necessary to amplify a laser beam output from an RF—CO₂ laser step by step, by arranging a plurality of amplifiers with different amplification gains for multistage amplification in a order from a smaller amplification gain to a larger amplification gain. Arranging a plurality of amplifiers for multistage amplification in this manner causes a driver laser to be larger in size and more complicated, resulting in deterioration of reliability thereof.

Here, as shown in FIG. 34A, it is considered to obtain a laser beam amplified about 30 to 100 times (energy thereof is denoted by X′ in FIG. 34A) from a laser beam output from a CO₂ laser by directly inputting a laser beam output from an RF—CO₂ laser (energy thereof is denoted by X (generally, about 1 mJ or less) in FIG. 34A) into a big size (having a high amplification gain) amplifier. In this case, however, efficiency is not good, because most of energy supplied from an external circuit (RF power source or the like) to an amplifier remains within the amplifier without being transmitted to a laser beam input from an RF—CO₂ laser. In addition, an amplifier for performing such amplification is very big in size, and a whole device size is even bigger than in the case arranging a plurality of amplifiers for multistage amplification described above. Therefore, it is more realistic to use a plurality of amplifiers arranged for multistage amplification rather than to use such a big amplifier.

By the way, in order to reduce a device size by reducing the number of amplification stages, there is known two-pass amplification in which a laser beam that has been amplified and output from an amplifier is input again into the amplifier and amplified again. FIG. 34B is a diagram showing an example of amplification characteristics in two-pass amplification. As shown in FIG. 34B, when a laser beam from a prior stage (energy thereof is denoted by Y in FIG. 34B) is input into an amplifier and an energy of the amplified laser beam Y′ exists within an amplification range, the amplified laser beam can be input into the amplifier again and amplified again to obtain highly efficient amplification.

It is known that the self oscillation occurs more easily when a value of A in the following formula (I) is larger,

A=gₒ×L (1)

where gₒ is an amplification gain and L is an amplification gain length (discharge length). In a case of two-pass amplification, since an amplification gain length (discharge length) is two times that in one-pass amplification, a self oscillation becomes to occur two times more easily than in one-pass amplification.

### SUMMARY OF THE INVENTION

The present invention has been achieved in view of the above-mentioned problems. A purpose of the present invention is to provide a driver laser for an extreme ultra violet light source device that can suppress a self-oscillation light and perform laser beam amplification efficiently, and also can reduce a size of the device.

In order to accomplish the above purpose, a driver laser according to one aspect of the present invention is a driver laser for an extreme ultra violet light source device which generates extreme ultra violet light by irradiating a target material with a laser beam output from a laser light source and thereby turning the target material into plasma, the driver laser comprising: an oscillator for generating a laser beam by oscillation to output the generated laser beam; and at least one amplifier for receiving the laser beam output from the oscillator and amplifying the laser beam to output the amplified laser beam, wherein the amplifier includes: a discharge unit which has a first window and a second window for inputting and outputting a laser beam, and amplifies the laser beam input into the first window to output the amplified laser beam from the second window and amplifies the laser beam input into the second window to output the amplified laser beam from the first window, by using energy of a laser medium excited by discharge; a first optical system which leads the laser beam output from the second window of the discharge unit to the second window of the discharge unit; a second optical system which leads the laser beam output from the oscillator to the first window of the discharge unit and leads the laser beam output from the first window of the discharge unit to a predetermined direction, and at least one self-oscillation light attenuation means which attenuates self-oscillation light output from the first window and/or the second window of the discharge unit.

According to the present invention, since self-oscillation light is suppressed, amplification of the laser beam is performed efficiently and a device size can be reduced.

### BRIEF DESCRIPTION OF THE DRAWINGS

FIG. 1 is a schematic diagram showing an outline of an LPP type EUV light source device that employs a driver laser according to embodiments of the present invention.

FIG. 2 is a schematic diagram showing a principle of a driver laser according to a first embodiment of the present invention.

FIG. 3 is a schematic diagram showing incident angle-reflectance characteristics of a Brewster plate.

FIG. 4 is a schematic diagram showing an oscillator shown in FIG. 2.

FIG. 5 is a schematic diagram showing an amplifier shown in FIG. 2.

FIG. 6 is schematic diagram showing an example of a self-oscillation light filter shown in FIG. 5.

FIG. 7 is a schematic diagram showing input laser beam intensity to transmittance characteristics of a saturable absorber.

FIG. 8 is a schematic diagram showing input laser beam intensity to transmittance characteristics of an SF₆ mixed gas.

FIGS. 9A and 9B are schematic diagrams showing waveforms of laser beams input into and output from the amplifier.

FIG. 10 is a schematic diagram showing a variation of a driver laser according to the first embodiment of the present invention.

FIG. 11 is a schematic diagram showing a variation of the driver laser according the first embodiment of the present invention.

FIG. 12 is a schematic diagram showing another example of the self-oscillation light filter shown in FIG. 5.

FIGS. 13A to 13C are schematic diagrams showing other examples of the self-oscillation light filter shown in FIG. 5.

FIG. 14 is a schematic diagram showing a driver laser according to a second embodiment of the present invention.

FIG. 15 is a schematic diagram showing an amplifier shown in FIG. 14.

FIG. 16 is a schematic diagram showing a variation of the driver laser according to the second embodiment of the present invention.

FIG. 17 is a schematic diagram showing a variation of the driver laser according to the second embodiment of the present invention.

FIG. 18 is a schematic diagram showing a driver laser according to a third embodiment of the present invention.

FIG. 19 is a schematic diagram showing a driver laser according to a fourth embodiment of the present invention.

FIG. 20 is a schematic diagram showing a driver laser according to a fifth embodiment of the present invention.

FIG. 21 is a schematic diagram showing a driver laser according to a sixth embodiment of the present invention.

FIG. 22 is a schematic diagram showing a driver laser according to a seventh embodiment of the present invention.

FIG. 23 is a schematic diagram showing a driver laser according to an eighth embodiment of the present invention.

FIG. 24 is a schematic diagram showing a driver laser according to a ninth embodiment of the present invention.

FIG. 25 is a schematic diagram showing an example of an optical system 111 shown in FIG. 24.

FIGS. 26A and 26B are schematic diagrams showing other examples of the optical system 111 shown in FIG. 24.

FIG. 27 is a schematic diagram showing further another example of the optical system 111 shown in FIG. 24.

FIG. 28 is a schematic diagram showing a driver laser according to a tenth embodiment of the present invention.

FIG. 29 is a schematic diagram showing a driver laser according to an eleventh embodiment of the present invention.

FIG. 30 is a schematic diagram showing a driver laser according to a twelfth embodiment of the present invention.

FIG. 31 is a schematic diagram showing a driver laser according to a thirteenth embodiment of the present invention.

FIG. 32 is a schematic diagram showing a driver laser according to a fourteenth embodiment of the present invention.

FIG. 33 is a schematic diagram showing a constitution of an oscillation amplification type laser.

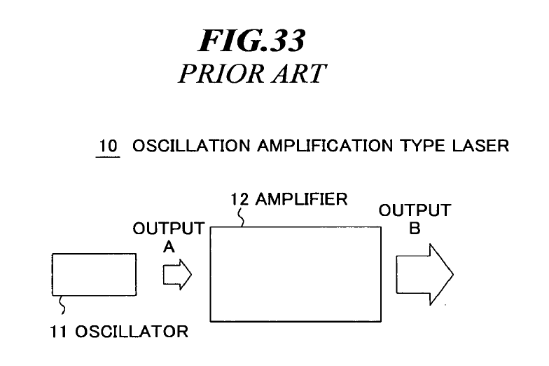

FIGS. 34A and 34B are schematic diagrams showing amplification characteristics of amplifiers.

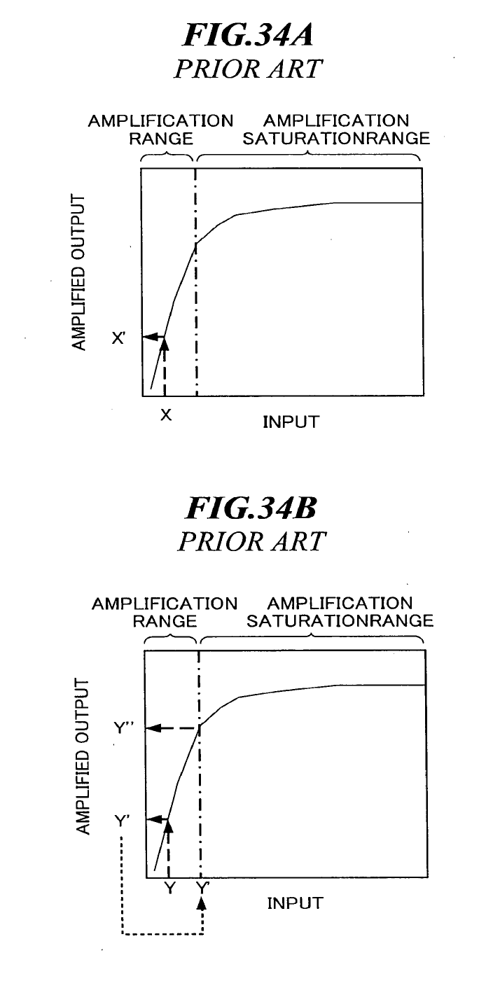

### DESCRIPTION OF THE PREFERRED EMBODIMENTS

Hereinafter, embodiments of the present invention will be described in detail referring to the drawings. The same component is denoted by the same reference numeral and explanation thereof is omitted.

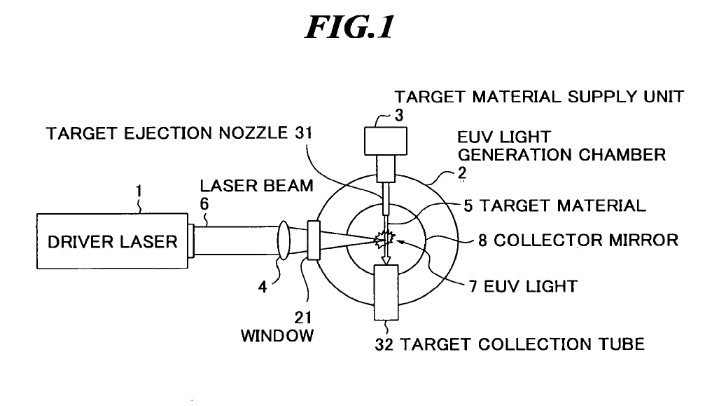

FIG. 1 is a schematic diagram showing an outline of an LPP type EUV light source device which employs a driver laser for an extreme ultra violet light source (hereinafter, simply referred to as “driver laser”) according to the present invention. As shown in FIG. 1, the LPP type EUV light source device includes a driver laser 1, an EUV light generation chamber 2, a target material supply unit 3, and an optical system 4.

The driver laser 1 is an oscillation amplification type laser device generating a driving laser beam to be used for excitation of a target material. A constitution of the driver laser 1 will be described in detail hereinafter.

The EUV light generation chamber 2 is a vacuum chamber in which EUV light is generated. In the EUV light generation chamber 2, there is provided a window 21 for transmitting a laser beam 6 generated in the driver laser 1 into the EUV light generation chamber 2. Also, a target ejection nozzle 31, a target collection tube 32, and a collector mirror 8 are disposed within the EUV light generation chamber 2.

The target material supply unit 3 supplies a target material to be used for generating EUV light into the EUV light generation chamber 2 via the target ejection nozzle 31 that is a part of the target material supply unit 3. Among the supplied target material, the unneeded target material that has not been irradiated with a laser beam is collected by the target collection tube 32. As the target material, various publicly known materials can be used (such as tin (Sn), xenon (Xe), etc.). Also, a state of the target material may be any of solid, liquid, and gas, and the material may be supplied into a space in the EUV light generation chamber 2 in any publicly known way such as a continuous flow (target jet) or a liquid droplet. For example, in the case where a liquid xenon (Xe) target is used for a target material, the target material supply unit 3 is constituted by a gas bomb for supplying a high purity xenon gas, a mass-flow controller, cooling apparatus for liquidizing the xenon gas, a target ejection nozzle or the like. Further, when a droplet is generated, a vibration device such as a piezoelectric element is added to the constitution thereof.

The optical system 4, including a collector lens, for example, collects the laser beam 6 output from the driver laser 1 so as to form a focal point on a path of the target material. Thereby, a target material 5 is excited and turned into plasma and EUV light 7 is generated.

The collector mirror 8 is a concave mirror with a Mo/Si film formed on a surface thereof for reflecting a light of 13.5 nm in wavelength, for example, with high reflectance, and collects the generated EUV light 7 by reflection to guide into a transmission optical system. Further, the EUV light is guided into exposure equipment or the like via the transmission optical system. Here, the collector mirror 8 collects the EUV light in the upward direction perpendicular to the drawing plane in FIG. 1.

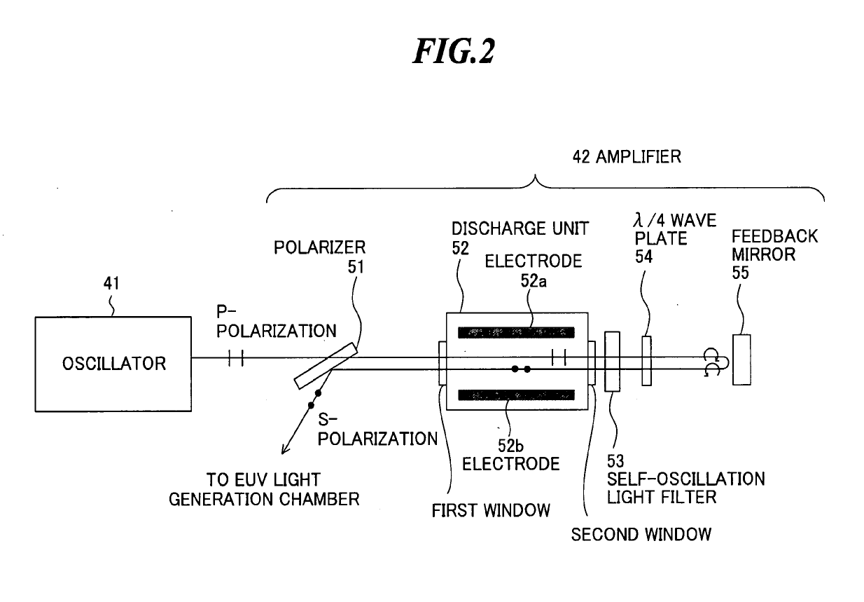

Next, a driver laser according to a first embodiment of the present invention will be described. FIG. 2 is a schematic diagram showing a principle of a driver laser according to the first embodiment. As shown in FIG. 2, the driver laser includes an oscillator 41 for generating a laser beam by oscillation due to resonance to output the generated laser beam, and an amplifier 42 for amplifying a laser beam emitted from the oscillator 41. The amplifier 42 has a polarizer 51, a discharge unit 52, a self-oscillation light filter 53, a λ/4 wave plate 54 and a feedback mirror 55.

The polarizer 51 make a laser beam (here, P-polarized) output from the oscillator 41 to pass therethrough such that the laser beam is input into the discharge unit 52 through a first window thereof. Further, the polarizer 51 reflects a laser beam (here, S-polarized) output from the discharge unit 52 through a second window thereof to the direction of the EUV light generation chamber. Here, as the polarizer 51, a thin film polarizer, a Brewster plate or the like may be used. Even if either one is used as the polarizer 51, it is preferable to arrange the polarizer to have a Brewster's angle against an optical axis of the laser beam.

In a case where a thin film polarizer containing ZnSe as a mother material is used as the polarizer 51, a Brewster's angle is approximately 67.4° in the case where a CO₂ laser beam has wavelength of 10.6 μm. An S-polarization reflection surface of a thin film polarizer (surface on the side of the discharge unit 52 in the present embodiment) includes a coating that has high reflectance for S-polarized light and low reflectance for P-polarized light. A thin film polarizer having an S-polarization reflectance (RS) of 99% or higher and a P-polarization transmittance (TP) of 95% or higher is available currently. Note that, not limited to ZnSe, a material having a high transmittance for a CO₂ laser beam can be used as a mother material of a thin film polarizer.

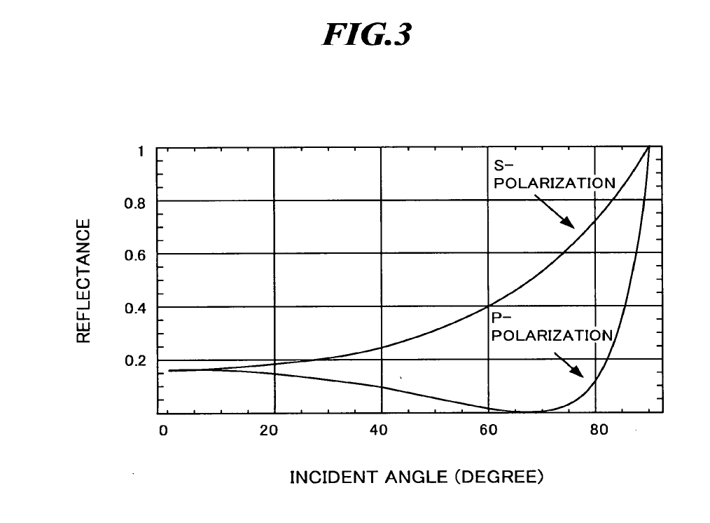

Next, an explanation will be provided for a case where a Brewster plate containing ZnSe as a mother material is used for the polarizer 51. FIG. 3 is a diagram showing a relationship between an incident angle and reflectance of a laser beam in a Brewster plate containing ZnSe as a mother material. As shown in FIG. 3, in the case of using a Brewster plate containing ZnSe as a mother material, a Brewster's angle is also approximately 67.4°. At the Brewster's angle, P-polarization reflectance is approximately 0% and S-polarization reflectance is approximately 50%. The S-polarization reflectance of a Brewster plate at the Brewster's angle (approximately 50%) is only about a half of the S-polarization reflectance of the thin film polarizer at the Brewster's angle described above (approximately 99% or higher). In a case where intensity of an amplified laser beam is high, however, it is preferable to use a Brewster plate rather than a thin film polarizer. The reason is that a coating is provided on a thin film polarizer and the coating deteriorates when amplified laser beam intensity is high, while any coating is not provided on a Brewster plate and can not deteriorate. Note that, not limited to ZnSe, a material having a high transmittance for a CO₂ laser beam can be used as a mother material of a Brewster plate.

Referring to FIG. 2 again, a laser medium is filled within the discharge unit 52 and the laser medium can be excited by a discharge between a pair of electrodes 52a and 52b disposed within the discharge unit 52 at a predetermined timing. A laser beam (P-polarized) input into the discharge unit 52 is amplified during passing through the excited laser medium.

The laser beam (P-polarized) amplified in the discharge unit 52 is transmitted through the second window and passes through the self-oscillation light filter 53. When a self oscillation has occurred in the discharge unit 52 and self-oscillation light has been output to the side of the self-oscillation light filter 53, the self-oscillation light filter 53 attenuates the self-oscillation light.

The laser beam (P-polarized) passed through the self-oscillation light filter 53 passes through the λ/4 wave plate 54. The λ/4 wave plate 54 converts the laser beam with linear polarization (here, P-polarization) into a laser beam with circular polarization (here, clockwise toward the traveling direction). The laser beam (with circular polarization clockwise toward the traveling direction) passed through the λ/4 wave plate 54 is reflected by the feedback mirror 55. The feedback mirror 55 converts the laser beam with circular polarization clockwise toward the traveling direction into a laser beam with circular polarization counter-clockwise toward the traveling direction. Here, a total reflection mirror or the like can be used for the feedback mirror 55.

The laser beam (with circular polarization counter-clockwise toward the traveling direction) reflected by the feedback mirror 55 passes through the λ/4 wave plate 54 again. The λ/4 wave plate 54 converts the laser beam with circular polarization (here, counter-clockwise toward the traveling direction) into a laser beam with linear polarization (here, S-polarization).

The laser beam passed through the λ/4 wave plate 54 (S-polarized) passes through the self-oscillation light filter 53 again and is transmitted through the second window to be input into the discharge unit 52 again. The laser beam (S-polarized) input again into the discharge unit 52 is amplified again during passing through the excited laser medium.

The laser beam amplified again in the discharge unit 52 (S-polarization) is reflected to the direction of the EUV light generation chamber (FIG. 1) by the polarizer 51.

In a case where the amplifier 42 does not have an optical resonator in this manner, a laser system having such a constitution is called a MOPA (master oscillator power amplifier) system. Note that the amplifier 42 may have an optical resonator. A laser system having such a constitution is called a MOPO (master oscillator power oscillator) system.

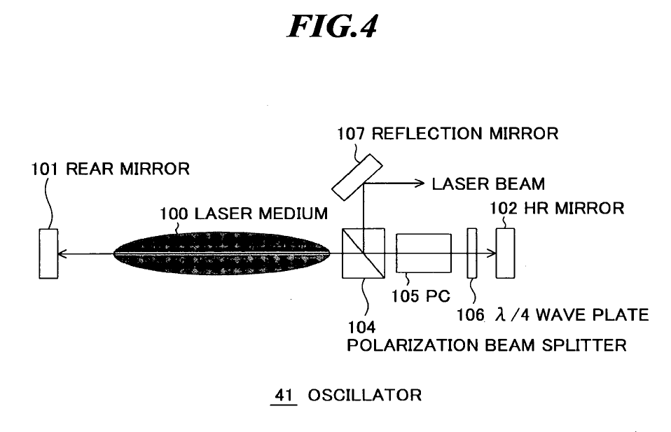

Next, a constitution of the oscillator 41 will be described referring to FIG. 4.

FIG. 4 is a schematic diagram showing a constitution of the oscillator 41. As shown in FIG. 4, this oscillator 41 includes a laser medium 100, a rear mirror 101 and a high reflectance (HR) mirror 102 which form a resonator, a polarization beam splitter 104, a Pockels cell (PC) 105, a λ/4 wave plate 106, and a reflection mirror 107.

The laser medium 100 is filled within a discharge tube (or chamber) (not shown in the drawing) and, the laser medium 100 can be excited by a discharge between a pair of electrodes disposed within the discharge tube (or chamber) (not shown in the drawing) at a predetermined timing. Here, the laser medium 100 may be a CO₂ laser gas containing carbon dioxide (CO₂), nitrogen (N₂), helium (He), and further if needed, hydrogen (H₂), carbon monoxide (CO), xenon (Xe), etc.

A laser beam is CW (continuous oscillation) excited or pulse excited by passing through the laser medium while traveling back and forth between the rear mirror 101 and the HR mirror 102.

The polarization beam splitter 104 separates incident light into P-polarized light and S-polarized light by outputting P-polarized light to the same direction as the traveling direction of the incident light and by outputting S-polarized light to a direction approximately perpendicular to the incident light.

The λ/4 wave plate 106 converts a laser beam passing therethrough with linear polarization into a laser beam with circular polarization and converts a laser beam with circular polarization into a laser beam with linear polarization.

Further, a Pockels cell (Q switch) is an optical element utilizing an EO effect (electro-optic effect) that a refractive index or an anisotropy of a crystal is varied by applying an electric field to the crystal. By controlling an electric field applied to a Pockels cell, it is possible to rotate a polarization plane of light passing therethrough by a desired angle. In the present embodiment, a laser beam is taken out upward in the drawing by controlling a switching of the Pockels cell 105, and therefore, the reflection mirror 107 is disposed for changing the direction of the taken-out laser beam. Note that a laser with such a constitution is called a Q-switched cavity-dumped laser.

By activating or deactivating the Pockels cell 105 at a predetermined timing, a laser beam to be output outside a resonator, which is formed by the rear mirror 101 and the HR mirror 102, is cut out by a desired pulse width. Thereby, a laser beam can be made to be a short pulse laser beam.

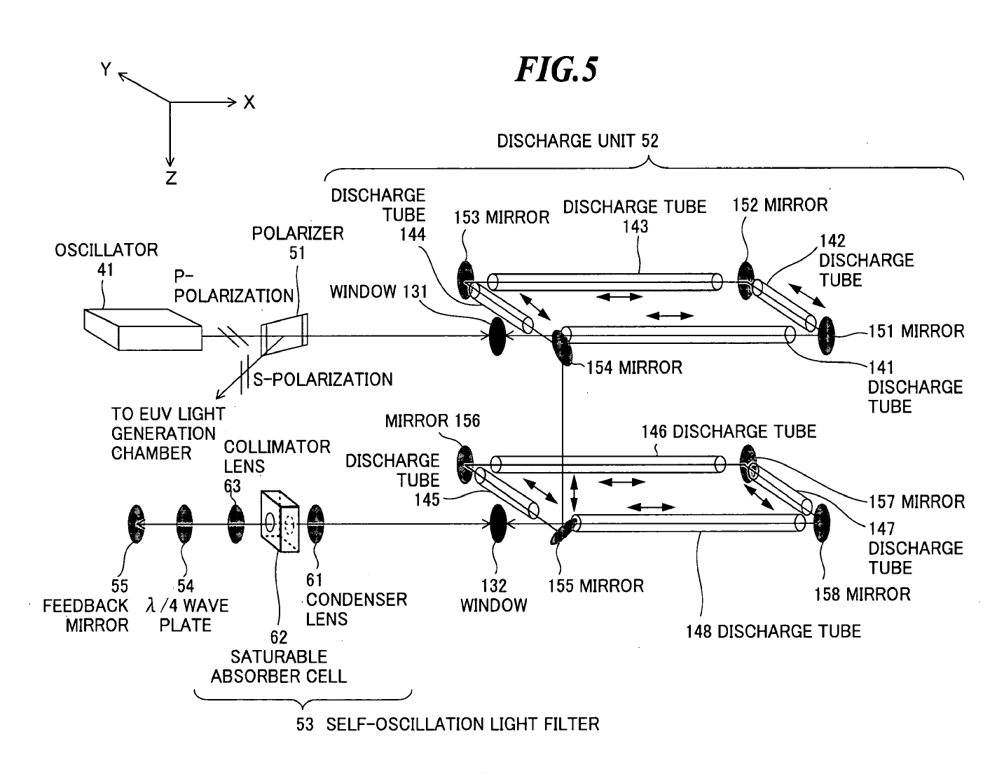

Next, a constitution of the amplifier 42 will be described referring to FIG. 5.

FIG. 5 is a schematic diagram showing a constitution of the amplifier 42. As shown in FIG. 5, the discharge unit 52 of the amplifier 42 includes windows 131 and 132, discharge tubes 141 to 148, and mirrors 151 to 158. A laser medium is filled within the discharge tubes 141 to 148, and the laser medium can be excited by a discharge at a predetermined timing between a pair of electrodes disposed in the discharge tubes 141 to 148, respectively. Here, the windows 131 and 132 may contain ZnSe or the like. Further, the laser medium may be a CO₂ laser gas containing carbon dioxide (CO₂), nitrogen (N₂), helium (He), and further if needed, hydrogen (H₂), carbon monoxide (CO), xenon (Xe), etc.

The first-pass amplification is performed in the discharge unit 52 for a laser beam (P-polarized) that has been output from the oscillator 41 and passed through the polarizer 51.

For details, a laser beam (P-polarized) output from the oscillator 41 and passed through the polarizer 51 passes through the window 131 and is input into the discharge tube 141 to be amplified. The laser beam amplified within the discharge tube 141 is reflected by the mirror 151 to the Y direction and input into the discharge tube 142 to be amplified. The laser beam amplified within the discharge tube 142 is reflected by the mirror 152 to the reverse X direction and input into the discharge tube 143 to be amplified. The laser beam amplified within the discharge tube 143 is reflected by the mirror 153 to the reverse Y direction and input into the discharge tube 144 to be amplified.

The laser beam amplified in the discharge tube 144 is reflected by the mirror 154 to the Z direction, and further reflected by the mirror 155 to the Y direction and input into the discharge tube 145 to be amplified. The laser beam amplified in the discharge tube 145 is reflected by the mirror 156 to the X direction and input into the discharge tube 146 to be amplified. The laser beam amplified in the discharge tube 146 is reflected by the mirror 157 to the reverse Y direction and input into the discharge tube 147 to be amplified. The laser beam amplified in the discharge tube 147 is reflected by the mirror 158 to the reverse X direction and input into the discharge tube 148 to be amplified.

The laser beam performed with the first-pass amplification in this manner passes through the window 132 and is input into the self-oscillation light filter 53. Here, when a self oscillation occurs in the discharge unit 52, self-oscillation light and a main pulse performed with the first-pass amplification pass through the window 132 and are input into the self-oscillation light filter 53.

The self-oscillation light filter 53 includes a collector lens 61, a saturable absorber cell 62 filled with a saturable absorber that is a material absorbing a low intensity laser beam and transmitting a high intensity laser beam, and a collimator lens 63.

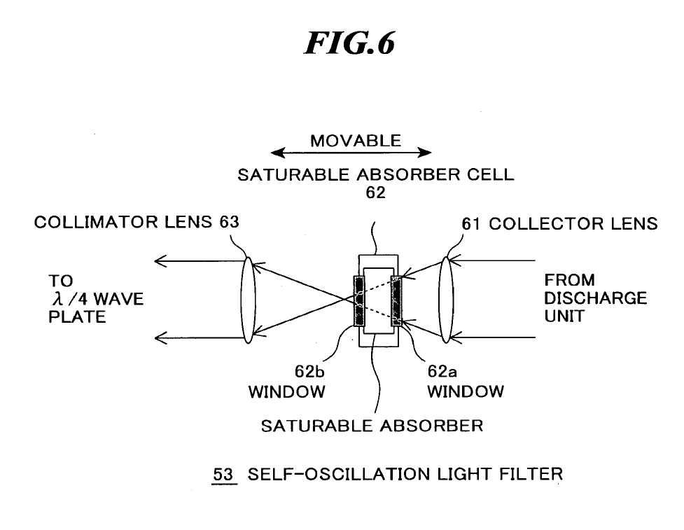

FIG. 6 is a schematic diagram showing the self-oscillation light filter 53. As shown in FIG. 6, the saturable absorber cell 62 is movably disposed along an optical axis of the laser beam between the condenser lens 61 and the collimator lens 63. The condenser lens 61 collects the laser beam output from the discharge unit 52. In the saturable absorber cell, windows 62a and 62b are provided for transmitting a laser beam, and the laser beam is transmitted through the window 62a to be input into the saturable absorber cell 62.

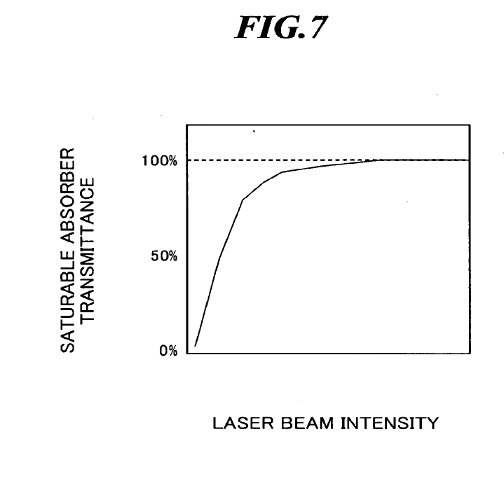

FIG. 7 is a diagram showing a relationship between intensity and transmittance of a laser beam to be input into a saturable absorber. As shown in FIG. 7, a saturable absorber absorbs a low intensity laser beam (low transmittance for a low intensity laser beam), and transmits a high intensity laser beam (high transmittance for a high intensity laser beam). Generally, intensity of self-oscillation light is lower than that of a main pulse. Therefore, when a self oscillation occurs in the discharge unit 52, a saturable absorber can absorb self-oscillation light and transmit a main pulse.

Here, a mixed gas containing SF₆ is generally used as a saturable absorber for a CO₂ laser beam. When the mixed gas containing SF₆ is used as a saturable absorber, He, N₂, Ar or the like can be used as a buffer gas. Laser beam absorption characteristics of a saturable absorber can be adjusted by a contained amount of SF₆ in the mixed gas, a kind of the buffer gas and a contained amount thereof, mixing further another gas other than the buffer gas, adjusting an optical path length of a laser beam that passes through the saturable absorber, etc. Other than an SF₆ mixed gas, ethanol (C₂H₅OH), freon 12 (CCl₂F₂), formic acid (HCOOH) or the like can be used as a saturable absorber.

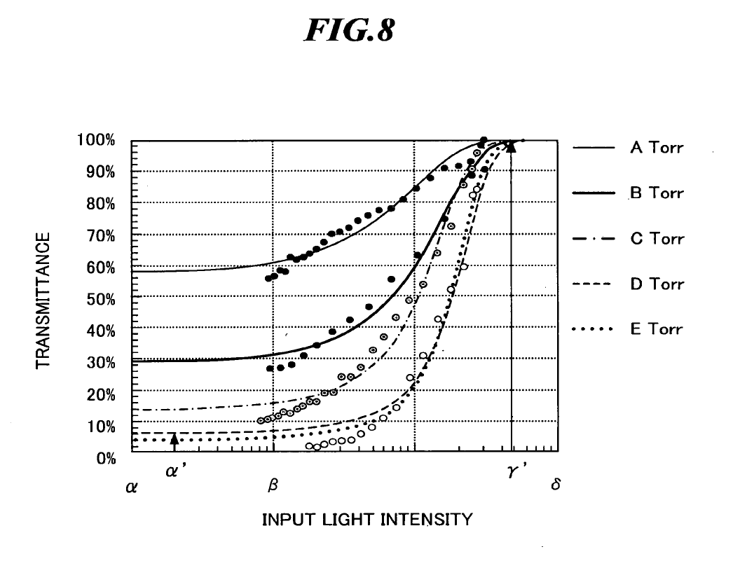

FIG. 8 is a diagram showing relationships between intensity and transmittance of an input laser beam for a first to fifth mixed gases that are different in contained amounts of SF₆. In FIG. 8, the contained amounts of SF₆ for the first to fifth mixed gases are shown by partial pressures of SF₆, respectively. Here, a partial pressure A of SF₆ in the first mixed gas<a partial pressure B of SF₆ in the second mixed gas<a partial pressure C of SF₆ in the third mixed gas<a partial pressure D of SF₆ in the fourth mixed gas<a partial pressure E of SF₆ in the fifth mixed gas.

As shown in FIG. 8, in the case where about 95% or more of self-oscillation light having intensity a′ is required to be absorbed, the fourth mixed gas (SF₆ partial pressure D) or the fifth mixed gas (SF₆ partial pressure E) may be used as a saturable absorber.

Further, as shown in FIG. 8, if a main pulse has intensity γ′, about 100% of the main pulse passes through the SF₆ mixed gasses. If intensity of a main pulses is less than γ′, the saturable absorber cell 62 may be moved along an optical axis of the laser beam to be closer to a focal point of the condenser lens 61. This is because laser beam intensity becomes lower at a point farther from the focal point of the condenser lens 61, and becomes higher at a point nearer to the focal point of the condenser lens 61.

Referring to FIG. 6 again, the laser beam passed through the saturable absorber passes through the window 62b and is input into the collimator lens 63 to be collimated.

Note that, when a saturable absorber has absorbed self-oscillation light, temperature thereof is increased by the energy of the self-oscillation light. Also, saturable absorption characteristics of a saturable absorber deteriorate as the temperature thereof is increased. Therefore, it may be considered to let a saturable absorber flow by providing an intake vent and an exhaust vent to the saturable absorber cell 62.

Referring to FIG. 5 again, the laser beam (P-polarized) passed through the self-oscillation light filter 53 passes through the λ/4 wave plate 54. The λ/4 wave plate 54 converts the laser beam with linear polarization (here, P-polarization) into a laser beam with circular polarization (here, clockwise toward the traveling direction). The laser beam passed through the λ/4 wave plate 54 is reflected by the feedback mirror 55 to the X direction. The feedback mirror converts the laser beam with circular polarization clockwise toward the traveling direction into a laser beam with circular polarization counter-clockwise toward the traveling direction.

The laser beam reflected by the feedback mirror 55 to the X direction (with circular polarization counter-clockwise toward the traveling direction) passes again through the λ/4 wave plate 54. The λ/4 wave plate 54 converts the laser beam with circular polarization (here, counter-clockwise toward the traveling direction) into a laser beam with linear polarization (here, S-polarization). The laser beam (S-polarized) passed through the λ/4 wave plate 54 passes again through the self-oscillation light filter 53.

The second-pass amplification is performed for the laser beam (S-polarized) passed through the self-oscillation light filter 53 in the discharge unit 52.

For details, the laser beam (S-polarized) passed again through the self-oscillation light filter 53 passes through the window 132 and is input into the discharge tube 148 to be amplified. The laser beam amplified within the discharge tube 148 is reflected by the mirror 158 to the Y direction and input into the discharge tube 147 to be amplified. The laser beam amplified within the discharge tube 147 is reflected by the mirror 157 to the reverse X direction and input into the discharge tube 146 to be amplified. The laser beam amplified within the discharge tube 146 is reflected by the mirror 156 to the reverse Y direction and input into the discharge tube 145 to be amplified.

The laser beam amplified within the discharge tube 145 is reflected by the mirror 155 to a reverse Z direction, and further reflected by the mirror 154 to the Y direction and input into the discharge tube 144 to be amplified. The laser beam amplified within the discharge tube 144 is reflected by the mirror 153 to the X direction and input into the discharge tube 143 to be amplified. The laser beam amplified within the discharge tube 143 is reflected by the mirror 152 to the reverse Y direction and input into the discharge tube 142 to be amplified. The laser beam amplified within the discharge tube 142 is reflected by the mirror 151 to the reverse X direction and input into the discharge tube 141 to be amplified.

The laser beam performed with the second-pass amplification as described above passes through the window 131 and is reflected by the polarizer 51 to the direction of the EUV light generation chamber (FIG. 1).

Referring to FIG. 1 again, the laser beam emitted from the driver laser 1 is collected on a path of a target material by the optical system 4. Thereby, the target material 5 is excited and turned into plasma to generate the EUV light 7.

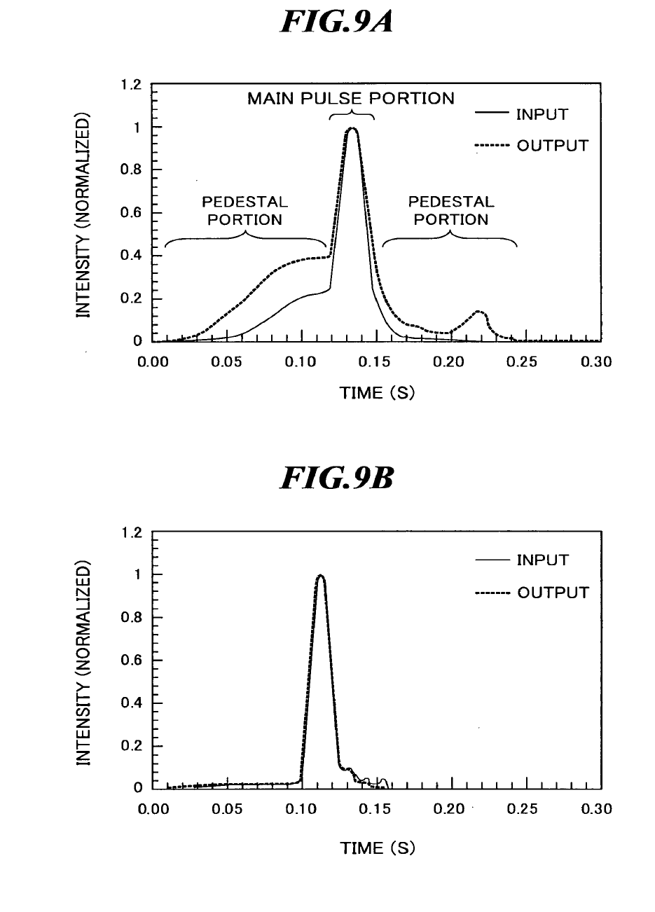

Next, operation of the present embodiment will be described referring to FIGS. 9A and 9B.

FIG. 9A is a diagram showing a normalized waveform of an input laser beam emitted from the discharge unit 52 to the side of the feedback mirror 55 and reflected by the feedback mirror 55 to be input again into the discharge unit 52 (corresponding to an output laser beam of the first pass, that is, an input laser beam of the second pass), and a normalized waveform of a laser beam emitted from the discharge unit 52 based on amplification of such an input laser beam to the side of the polarizer 51 (corresponding to an output laser beam of the second pass), when a self oscillation has occurred in the discharge unit 52 in the case where the self-oscillation light filter 53 is assumed not to exist. When a self oscillation has occurred in the discharge unit 52, self-oscillation light appears in the waveform as a pedestal portion as shown by a solid line in FIG. 9A. When such a laser beam has been reflected by the feedback mirror 55 and input into the discharge unit 52, the pedestal portion is amplified as well in the second-pass amplification as shown by a broken line in FIG. 9A. If a part of discharge energy within the discharge unit 52 is used for amplifying the pedestal portion in the second-pass amplification of a main pulse in this manner, discharge energy becomes less for amplifying a main pulse portion.

On the other hand, FIG. 9B is a diagram showing a normalized waveform of an input laser beam emitted from the discharge unit 52 to the side of the feedback mirror 55 and reflected by the feedback mirror 55 to be input again into the discharge unit 52 (corresponding to an output laser beam of the first pass, that is, an input laser beam of the second pass), and a normalized wave form of a laser beam output from the discharge unit 52 based on amplification of such an input laser beam to the side of the polarizer 51 (corresponding to an output laser beam of the second pass), when a self oscillation has occurred in the discharge unit 52 in the present embodiment. In the present embodiment, even if a self oscillation occurs in the discharge unit 52 (refer to the pedestal portion in FIG. 9A), the self-oscillation light filter 53 can attenuate self-oscillation light. Therefore, as shown by a solid line in FIG. 9B, intensity of a pedestal portion becomes very weak for an input laser beam reflected by the feedback mirror 55 to be input again into the discharge unit 52 (corresponding to an output laser beam of the first pass, that is, an input laser beam of the second pass). Thereby, in the second-pass amplification, it is possible to minimize energy used for amplifying the pedestal portion in the discharge energy within the discharge unit 52. Therefore, as shown by a broken line in FIG. 9B, the discharge energy within the discharge unit 52 can be used efficiently for amplifying a main pulse portion.

In this manner, according to the present embodiment, even if a self oscillation occurs in the discharge unit 52, self-oscillation light can be attenuated by the self-oscillation light filter 53, and as a result, amplification of a main pulse can be performed efficiently. Also, by performing two-pass amplification, the number of amplifier stages can be reduced to make a device size smaller.

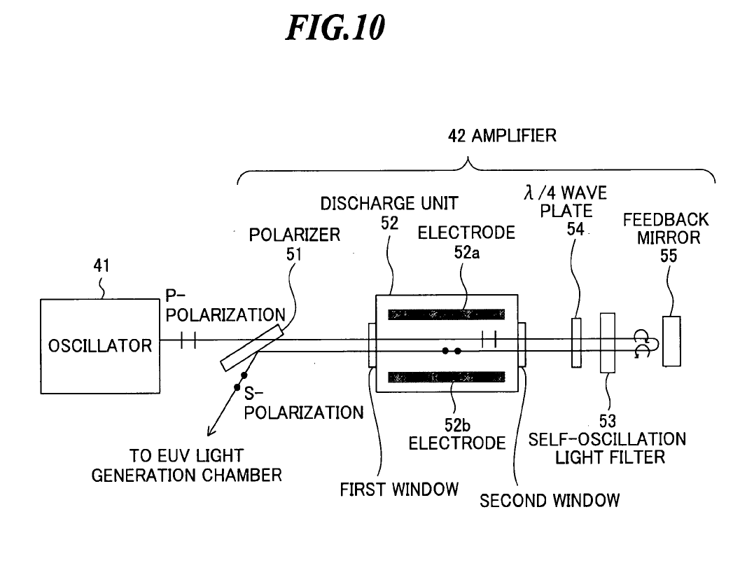

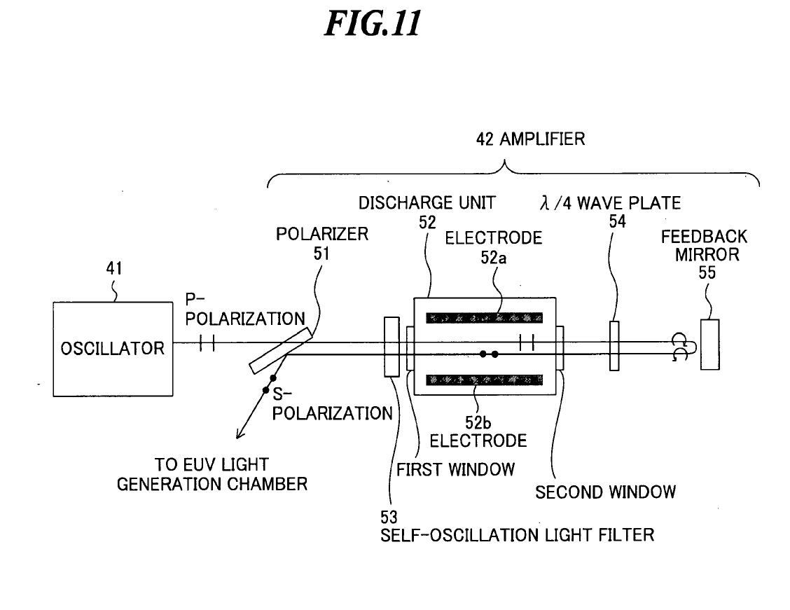

Note that, although the self-oscillation light filter 53 is disposed between the discharge unit 52 and the λ/4 wave plate 54 in the present embodiment as shown in FIG. 2, the self-oscillation light filter 53 may be disposed between the λ/4 wave plate 54 and the feedback mirror 55 as shown in FIG. 10 or between the polarizer 51 and the discharge unit 52 as shown in FIG. 11.

The self-oscillation light filter 53 is preferably disposed between the discharge unit 52 and the λ/4 wave plate 54 (FIG. 2) or between the λ/4 wave plate 54 and the feedback mirror 55 (FIG. 10), rather than between the polarizer 51 and the discharge unit 52 (FIG. 11). The reason is as follows. When the self-oscillation light filter 53 is disposed between the discharge unit 52 and the λ/4 wave plate 54 (FIG. 2) or between the λ/4 wave plate 54 and the feedback mirror 55 (FIG. 10), the self-oscillation light filter 53 may absorb only relatively weak self-oscillation light energy that is not amplified. On the other hand, when the self-oscillation light filter 53 is disposed between the polarizer 51 and the discharge unit 52 (FIG. 11), temperature of a saturable absorber is easily increased, since the self-oscillation light filter 53 has to absorb self-oscillation light with strong energy that was generated in the discharge unit 52, passed through a path consisting of the discharge unit 52, the λ/4 wave plate 54, the feedback mirror 55, the λ/4 wave plate 54, and the discharge unit 52, and then has been amplified in the discharge unit 52. Also, when the self-oscillation light is amplified in the discharge unit 52 after passing through the above described path, discharge energy for amplifying a main pulse portion in the discharge energy within the discharge unit 52 becomes less.

Further, a plurality of self-oscillation light filters may be disposed at a plurality of positions selected out of a position between the discharge unit 52 and the λ/4 wave plate 54 (FIG. 2), a position between the λ/4 wave plate 54 and the feedback mirror 55 (FIG. 10), and a position between the polarizer 51 and the discharge unit 52 (FIG. 11).

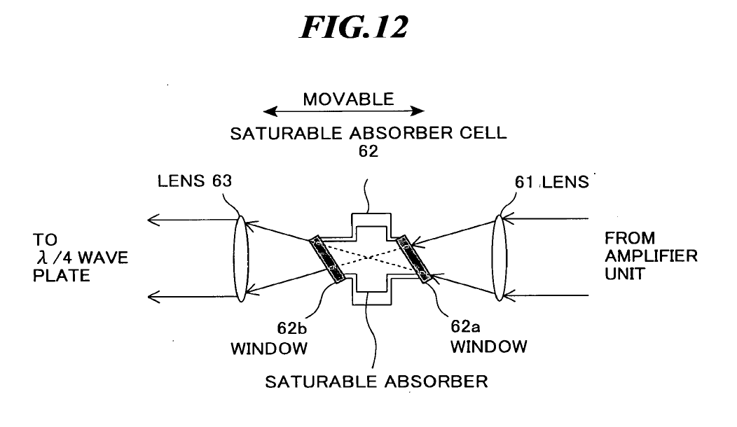

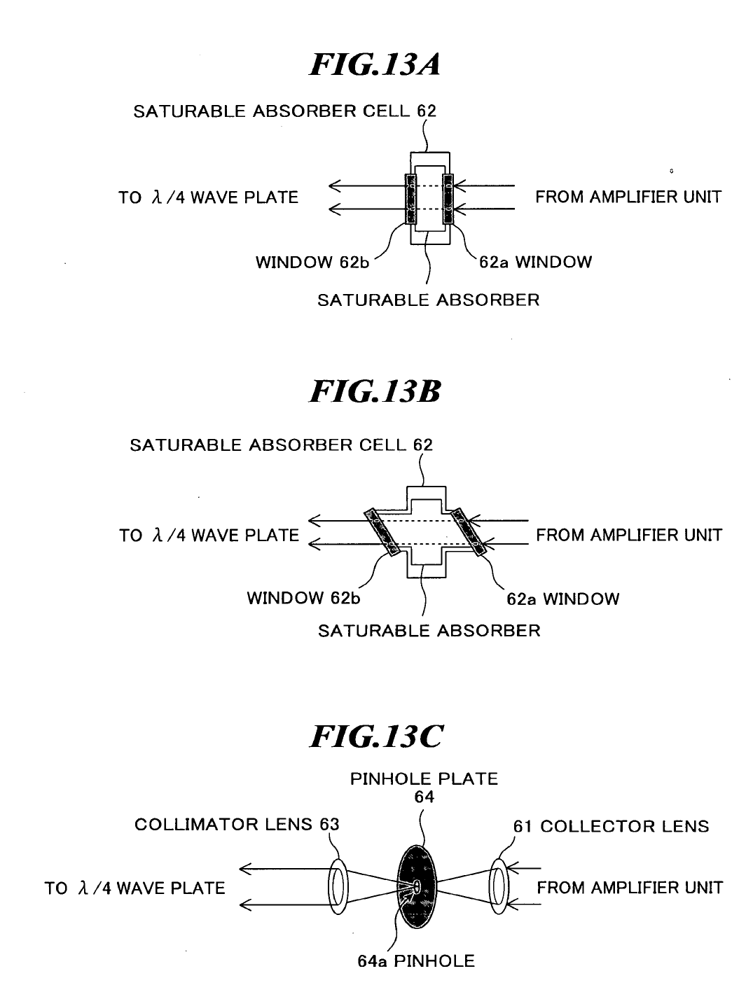

Furthermore, although the windows 62a and 62b of the saturable absorber cell 62 are provided so as to be approximately perpendicular to an optical axis of the laser beam in the present embodiment as shown in FIG. 6, the windows 62a and 62b of the saturable absorber cell 62 may be provided so as to make a Brewster's angle against the optical axis of the laser beam as shown in FIG. 12. Alternatively, the self-oscillation light filter may not include a condenser lens and a collimator lens as shown in FIGS. 13A and 13B. Moreover, as the self-oscillation light filter, a spatial filter, which includes a pinhole plate 64 formed with a pinhole 64a, a condenser lens 61 for collecting a laser beam to the pinhole 64a, and a collimator lens for collimating the laser beam that has passed through the pinhole 64a, may be used as shown in FIG. 13C.

Also, in the self-oscillation light filter shown in FIG. 6 or FIG. 12, the saturable absorber cell 62 may have a function of a pinhole plate as well, by making diameters of the windows 62a and 62b as small as a pinhole.

Next, a driver laser according to a second embodiment will be described.

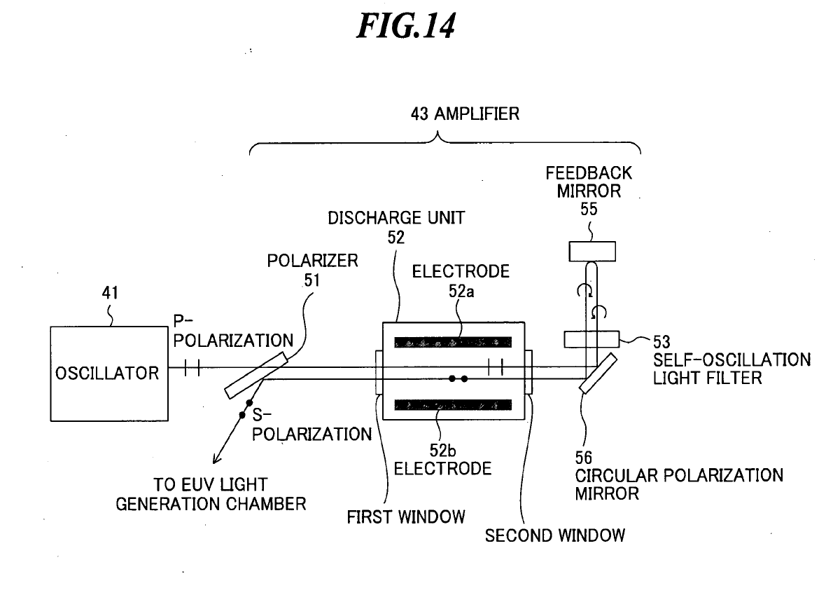

FIG. 14 is a schematic diagram showing a principle of a driver laser according to the second embodiment. As shown in FIG. 14, the driver laser includes an oscillator 41 and an amplifier 43 for amplifying a laser beam emitted from the oscillator 41. The amplifier 43 has a polarizer 51, a discharge unit 52, a circular polarization mirror (λ/4 phase retarding mirror) 56, a self-oscillation light filter 53, and a feedback mirror 55.

A laser beam (here, P-polarized) emitted from the oscillator 41 passes through the polarizer 51 and is transmitted through a first window to be input into the discharge unit 52. The laser beam (P-polarized) input into the discharge unit 52 from the polarizer 51 is amplified during passing through an excited laser medium.

The circular polarization mirror 56 converts the laser beam with linear polarization (P-polarization) amplified in the discharge unit 52 into a laser beam with circular polarization (here, counter-clockwise toward the traveling direction), and reflects the converted laser beam to the upward direction in the drawing.

The laser beam (with circular polarization counter-clockwise toward the traveling direction) reflected by the circular polarization mirror 56 passes through the self-oscillation light filter 53. The self-oscillation light filter 53 attenuates self-oscillation light, when a self-oscillation has occurred in the discharge unit 52.

The laser beam (with circular polarization counter-clockwise toward the traveling direction) passed through the self-oscillation light filter 53 is reflected by the feedback mirror 55 to the downward direction in the drawing. The feedback mirror 55 converts the laser beam with circular polarization counter-clockwise toward the traveling direction into a laser beam with circular polarization clockwise toward the traveling direction.

The laser beam (with circular polarization clockwise toward the traveling direction) reflected by the feedback mirror 55 passes through the self-oscillation light filter 53 again.

The laser beam (with circular polarization clockwise toward the traveling direction) passed again through the self-oscillation light filter 53 is reflected by the circular polarization mirror 56 to the left direction in the drawing. The circular polarization mirror 56 converts the laser beam with circular polarization (here, clockwise toward the traveling direction) into a laser beam with linear polarization (here, S-polarization) and reflects the converted laser beam.

The laser beam (S-polarized) reflected by the circular polarization mirror 56 is transmitted through a second window to be input again into the discharge unit 52. The laser beam (S-polarized) input again into the discharge unit 52 is amplified again during passing through the excited laser medium.

The laser beam (S-polarized) amplified again in the discharge unit 52 is reflected by the polarizer 51 to the direction of the EUV light generation chamber (FIG. 1).

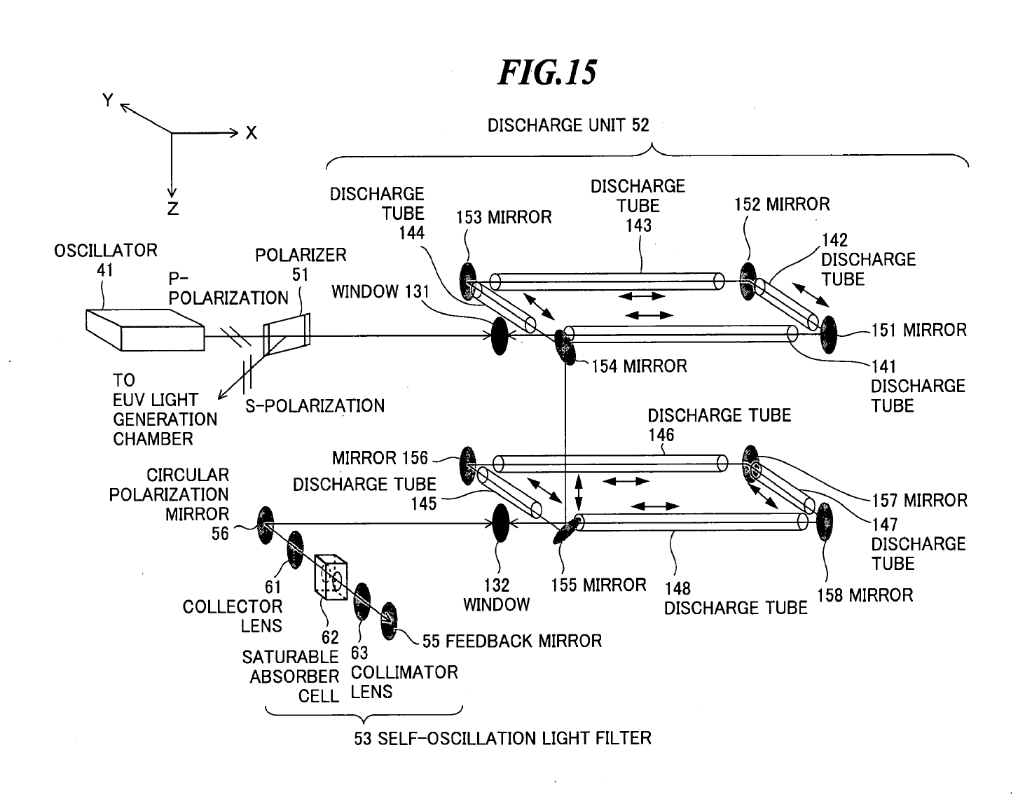

Next, a constitution of the amplifier 43 will be described referring to FIG. 15.

FIG. 15 is a schematic diagram showing a constitution of the amplifier 43.

For a laser beam (P-polarized) emitted from the oscillator 41 and passed through the polarizer 51, the first-pass amplification is performed in the discharge unit 52.

The laser beam performed with the first-pass amplification in the discharge unit 52 passes through a window 132 and is reflected by the circular polarization mirror 56 to the reverse Y direction. The laser beam (with circular polarization) reflected by the circular polarization mirror 56 is input into the self-oscillation light filter 53. Here, when a self oscillation has occurred in the first amplification, self-oscillation light and a main pulse performed with the first-pass amplification are input into the self-oscillation light filter 53.

The self-oscillation light filter 53 can absorb the self-oscillation light and transmit the main pulse performed with the first-pass amplification, when the self oscillation has occurred in the discharge unit 52.

The laser beam (with circular polarization) passed through the self-oscillation filter 53 is reflected by the feedback mirror 55 to the Y direction. The feedback mirror converts the laser beam with circular polarization counter-clockwise toward the traveling direction into a laser beam with circular polarization clockwise toward the traveling direction.

The laser beam (with circular polarization clockwise toward the traveling direction) reflected by the feedback mirror 55 to the Y direction passes through the self-oscillation light filter 53 again.

The laser beam (with circular polarization clockwise toward the traveling direction) passed through the self-oscillation light filter 53 again is reflected by the circular polarization mirror 56 to the X direction.

For the laser beam (S-polarized) reflected by the circular polarization mirror 56 to the X direction, the second-pass amplification is performed in the discharge unit 52.

The laser beam performed with the second-pass amplification passes through a window 131 and is reflected by the polarizer 51 to the direction of the EUV light generation chamber (FIG. 1).

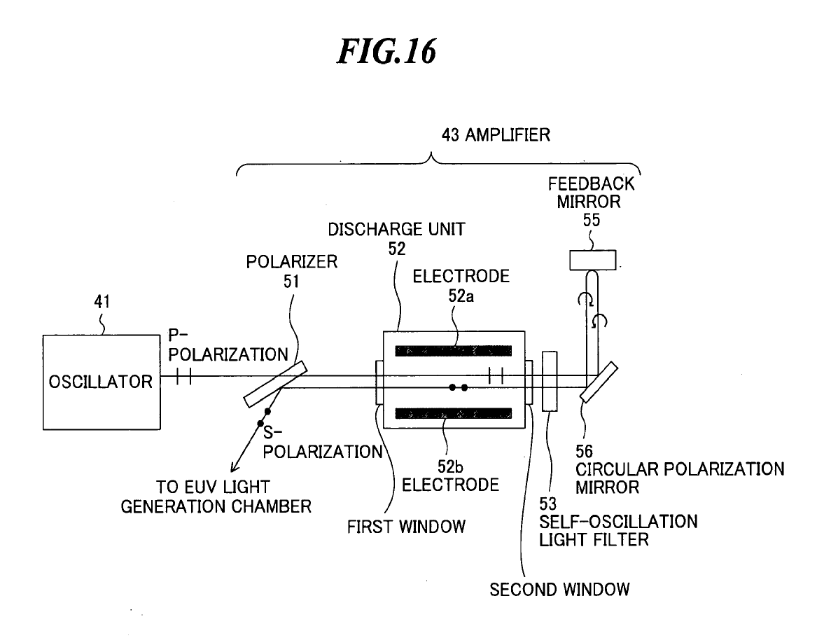

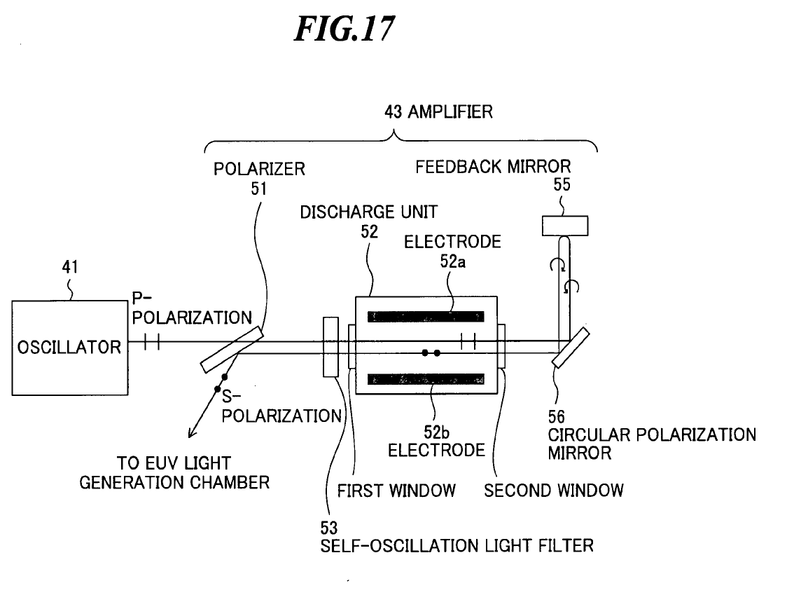

Note that, although the self-oscillation light filter 53 is disposed between the circular polarization mirror 56 and the feedback mirror 55 in the present embodiment as shown in FIG. 14, the self-oscillation light filter 53 may be disposed between the discharge unit 52 and the circular polarization mirror 56 as shown in FIG. 16, or between the polarizer 51 and the discharge unit 52 as shown in FIG. 17. The self-oscillation light filter 53 is disposed preferably between the circular polarization mirror 56 and the feedback mirror 55 (FIG. 14) or between the discharge unit 52 and the circular polarization mirror 56 (FIG. 16), rather than between the polarizer 51 and the discharge unit 52 (FIG. 17).

Alternatively, a plurality of self-oscillation light filters may be disposed at a plurality of positions selected out of a position between the circular polarization mirror 56 and the feedback mirror 55 (FIG. 14), a position between the discharge unit 52 and the circular polarization mirror 56 (FIG. 16), and a position between the polarizer 51 and the discharge unit 52 (FIG. 17).

Next, a driver laser according to a third embodiment of the present invention will be described.

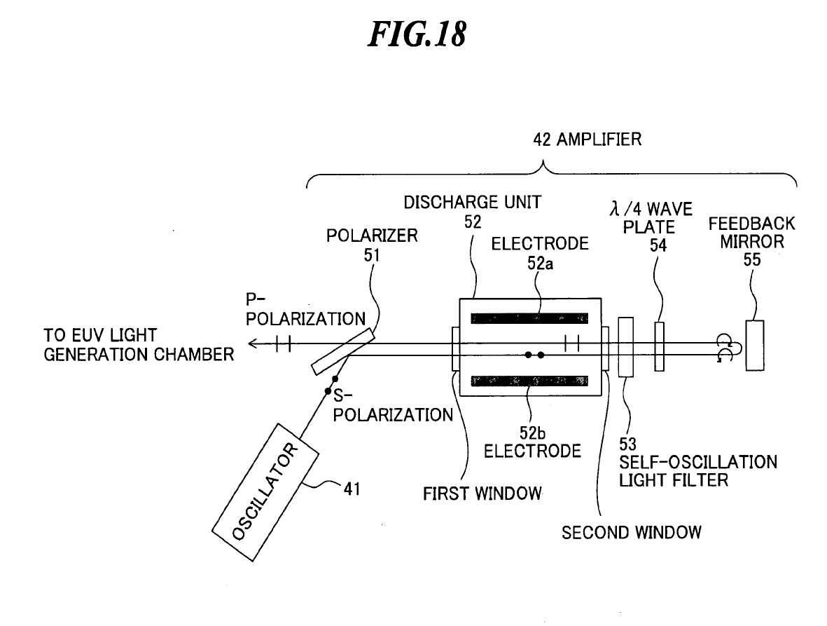

FIG. 18 is a schematic diagram showing a principle of a driver laser according to the third embodiment. As shown in FIG. 18, the driver laser includes an oscillator 41 and an amplifier 42.

The oscillator 41 emits a laser beam (here, S-polarized) to a reflection surface with a coating of the polarizer 51 (surface on the side of the discharge unit 52). The laser beam (S-polarized) emitted from the oscillator 41 is reflected by the polarizer 51 to the right direction in the drawing and transmitted through a first window to be input into the discharge unit 52. The laser beam (S-polarized) input into the discharge unit 52 is amplified during passing through an excited laser medium.

The laser beam (S-polarized) amplified in the discharge unit 52 passes through a self-oscillation light filter 53. When a self oscillation has occurred in the discharge unit 52 and self-oscillation light has been emitted to the side of the self-oscillation light filter 53, the self-oscillation light filter 53 attenuates the self-oscillation light.

The laser beam (S-polarized) passed through the self-oscillation light filter 53 passes through the λ/4 wave plate 54. The λ/4 wave plate 54 converts the laser beam with linear polarization (here, S-polarization) into a laser beam with circular polarization (here, counter-clockwise toward the traveling direction).

The laser beam (with circular polarization counter-clockwise toward the traveling direction) passed through the λ/4 wave plate 54 is reflected by the feedback mirror 55. The feedback mirror 55 converts the laser beam with circular polarization counter-clockwise toward the traveling direction into a laser beam with circular polarization clockwise toward the traveling direction.

The laser beam (with circular polarization clockwise toward the traveling direction) reflected by the feedback mirror 55 passes through the λ/4 wave plate 54 again. The λ/4 wave plate 54 converts the laser beam with circular polarization (here, clockwise toward the traveling direction) into a laser beam with linear polarization (here, P-polarized).

The laser beam (P-polarized) passed through the λ/4 wave plate 54 passes through the self-oscillation light filter 53 again and is transmitted through a second window to be input into the discharge unit 52 again. The laser beam input again into the discharge unit 52 is amplified again during passing through an excited laser medium.

The laser beam (P-polarized) amplified again in the discharge unit 52 passes through the polarizer 51 and is output to the direction of the EUV light generation chamber (FIG. 1) (the left direction in the drawing).

Note that, although the self-oscillation light filter 53 is disposed between the discharge unit 52 and the λ/4 wave plate 54 in the present embodiment as show in FIG. 18, the self-oscillation light filter 53 may be disposed between the λ/4 wave plate 54 and the feedback mirror 55, or between the polarizer 51 and the discharge unit 52. Alternatively, a plurality of self-oscillation light filters may be disposed at a plurality of positions selected out of a position between the discharge unit 52 and the λ/4 wave plate 54, a position between the λ/4 wave plate 54 and the feedback mirror 55, and a position between the polarizer 51 and the discharge unit 52.

Next, a driver laser according to a fourth embodiment of the present invention will be described.

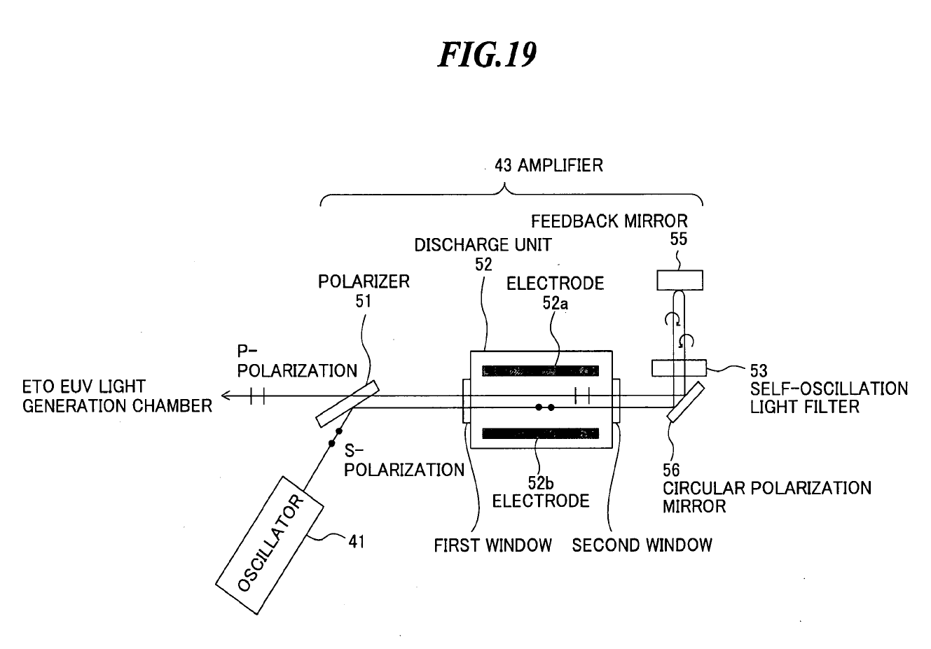

FIG. 19 is a schematic diagram showing a principle of a driver laser according to the fourth embodiment. As shown in FIG. 19, the driver laser includes an oscillator 41 and an amplifier 43.

The oscillator 41 emits a laser beam (here, S-polarized) to a reflection surface with a coating of a polarizer 51 (surface on the side of a discharge unit 52). The laser beam (S-polarized) emitted from the oscillator 41 is reflected by the polarizer 51 to the right direction in the drawing and is transmitted through a first window to be input into the discharge unit 52. The laser beam (S-polarized) input into the discharge unit 52 is amplified during passing through an excited laser medium.

The laser beam (S-polarized) amplified in the discharge unit 52 is reflected by a circular polarization mirror 56 to the upward direction in the drawing. The circular polarization mirror 56 converts the laser beam with linear polarization (S-polarization) amplified in the discharge unit 52 into a laser beam with circular polarization (here, clockwise toward the traveling direction) and reflects the converted laser beam.

The laser beam (with circular polarization clockwise toward the traveling direction) reflected by the circular polarization mirror 56 passes through the self-oscillation light filter 53. The self-oscillation light filter 53 attenuates self-oscillation light when a self-oscillation has occurred in the discharge unit 52.

The laser beam (with circular polarization clockwise toward the traveling direction) passed through the self-oscillation light filter 53 is reflected by the feedback mirror 55 to the downward direction in the drawing. The feedback mirror 55 converts the laser beam with circular polarization clockwise toward the traveling direction into a laser beam with circular polarization counter-clockwise toward the traveling direction.

The laser beam (with circular polarization counter-clockwise toward the traveling direction) reflected by the feedback mirror 55 passes through the self-oscillation light filter 53 again.

The laser beam (with circular polarization counter-clockwise toward the traveling direction) passed through the self-oscillation light filter 53 again is reflected by the circular polarization mirror 56 to the left direction in the drawing. The circular polarization mirror 56 converts the laser beam with circular polarization (here, counter-clockwise toward the traveling direction) into a laser beam with linear polarization (here, P-polarized) and reflects the converted laser beam.

The laser beam (P-polarized) reflected by the circular polarization mirror 56 is transmitted through a second window to be input into the discharge unit 52 again. The laser beam (P-polarized) input again into the discharge unit 52 is amplified again during passing through the excited laser medium.

The laser beam (P-polarized) amplified again in the discharge unit 52 passes through the polarizer 51 and is output to the direction of the EUV light generation chamber (FIG. 1) (the left direction in the drawing).

Note that, although the self-oscillation light filter 53 is disposed between the circular polarization mirror 56 and the feedback mirror 55 in the present embodiment as shown in FIG. 19, the self-oscillation light filter 53 may be disposed between the discharge unit 52 and the circular polarization mirror 56, or between the polarizer 51 and the discharge unit 52. Alternatively, a plurality of self-oscillation light filters may be disposed at a plurality of positions selected out of a position between the circular polarization mirror 56 and the feedback mirror 55, a position between the discharge unit 52 and the circular polarization mirror 56, and a position between the polarizer 51 and the discharge unit 52.

Next, a driver laser according to a fifth embodiment of the present invention will be described.

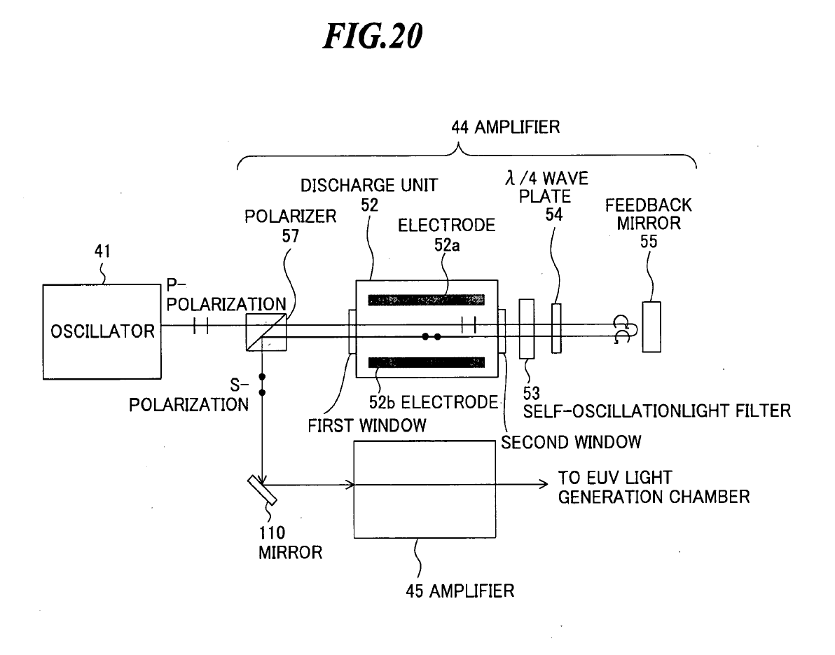

FIG. 20 is a schematic diagram showing a principle of a driver laser according to the fifth embodiment. As shown in FIG. 20, the driver laser includes an oscillator 41, an amplifier 44 for performing two-pass amplification, an amplifier 45 for performing one-pass amplification and a mirror 110. The amplifier 44 has a polarizer 57, a discharge unit 52, a self-oscillation light filter 53, a λ/4 wave plate 54 and a feedback mirror 55.

A laser beam (here, P-polarized) emitted from the oscillator 41 passes through the polarizer 57 and is transmitted through a first window to be input into the discharge unit 52. The laser beam (P-polarized) passed through the polarizer 57 and input into the discharge unit 52 is amplified during passing through an excited laser medium.

The laser beam (P-polarized) amplified in the discharge unit 52 passes through the self-oscillation light filter 53. When a self oscillation has occurred in the discharge unit 52 and self-oscillation light has been emitted to the side of the self-oscillation light filter 53, the self-oscillation light filter 53 attenuates the self-oscillation light.

The laser beam (P-polarized) passed through the self-oscillation light filter 53 passes through the λ/4 wave plate 54. The λ/4 wave plate 54 converts the laser beam with linear polarization (here, P-polarization) into a laser beam with a circular polarization (here, clockwise toward the traveling direction).

The laser beam (with circular polarization clockwise toward the traveling direction) passed through the λ/4 wave plate 54 is reflected by the feedback mirror 55. The feedback mirror 55 converts the laser beam with circular polarization clockwise toward the traveling direction into a laser beam with circular polarization counter-clockwise toward the traveling direction.

The laser beam (with circular polarization counter-clockwise toward the traveling direction) reflected by the feedback mirror 55 passes through the λ/4 wave plate 54 again. The λ/4 wave plate 54 converts the laser beam with circular polarization (here, counter-clockwise toward the traveling direction) into a laser beam with linear polarization (here, S-polarization).

The laser beam (S-polarized) passed through the λ/4 wave plate 54 passes through the self-oscillation light filter 53 again and is transmitted through a second window to be input into the discharge unit 52 again. The laser beam input again into the discharge unit 52 is amplified again during passing through the excited laser medium.

The laser beam (S-polarized) amplified again in the discharge unit 52 is reflected by the polarizer 57 to the downward direction in the drawing.

The laser beam reflected by the polarizer 57 to the downward direction in the drawing is reflected by the mirror 110 to the right direction in the drawing to be input into the amplifier 45. The laser beam input into the amplifier 45 is amplified and input into the EUV light generation chamber (FIG. 1).

In this manner, the amplifier 45 that performs one-pass amplification may be further provided in a stage following the amplifier 44 that performs two-pass amplification.

Note that, although the self-oscillation light filter 53 is disposed between the discharge unit 52 and the λ/4 wave plate 54 in the present embodiment as shown in FIG. 20, the self-oscillation light filter 53 may be disposed between the λ/4 wave plate 54 and the feedback mirror 55, or between the polarizer 57 and the discharge unit 52. Alternatively, a plurality of self-oscillation light filters may be disposed at a plurality of positions selected out of a position between the discharge unit 52 and the λ/4 wave plate 54 (FIG. 20), a position between the λ/4 wave plate 54 and the feedback mirror 55, and a position between the polarizer 57 and the discharge unit 52.

Next, a driver laser according to a sixth embodiment of the present invention will be described.

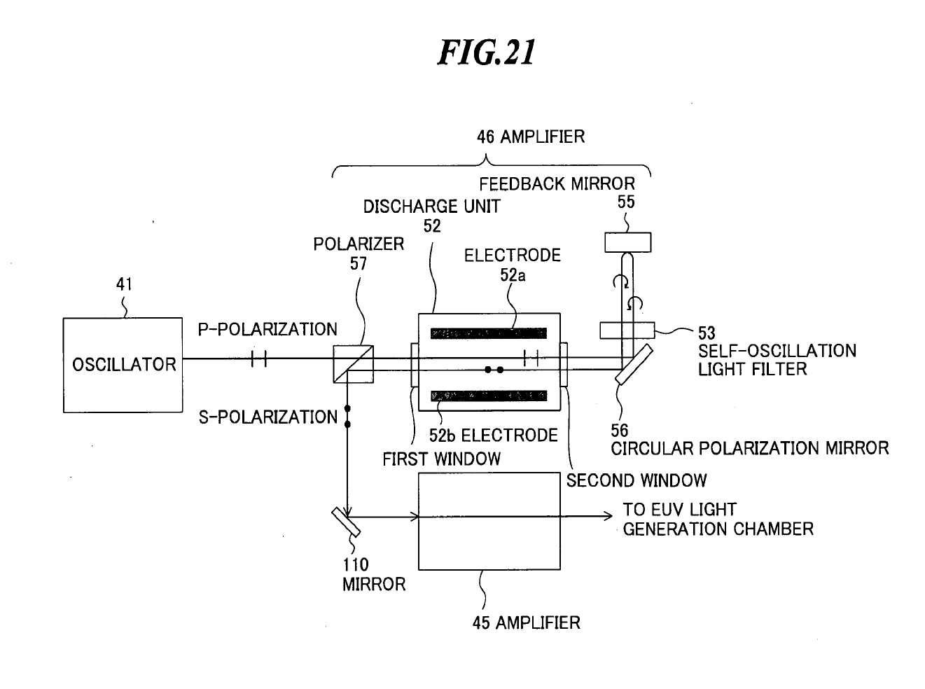

FIG. 21 is a schematic diagram showing a principle of a driver laser according to the sixth embodiment. As shown in FIG. 21, the driver laser includes an oscillator 41, an amplifier 46 for performing two-pass amplification, an amplifier 45 for performing one-pass amplification, and a mirror 110. The amplifier 46 has a polarizer 57, a discharge unit 52, a circular polarization mirror 56, a self-oscillation light filter 53, and a feedback mirror 55.

A laser beam (here, P-polarized) emitted from the oscillator 41 passes through the polarizer 57 and is transmitted through a first window to be input into the discharge unit 52. The laser beam (P-polarized) passed through the polarizer 57 and input into the discharge unit 52 is amplified during passing through an excited laser medium.

The circular polarization mirror 56 converts the laser beam with linear polarization (P-polarization) amplified in the discharge unit 52 into a laser beam with circular polarization (here, counter-clockwise toward the traveling direction) and reflects the converted laser beam to the upward direction in the drawing.

The laser beam (with circular polarization counter-clockwise toward the traveling direction) reflected by the circular polarization mirror 56 passes through the self-oscillation light filter 53. The self-oscillation light filter 53 attenuates self-oscillation light when a self oscillation has occurred in the discharge unit 52.

The laser beam (with circular polarization counter-clockwise toward the traveling direction) passed through the self-oscillation light filter 53 is reflected by the feedback mirror 55 to the downward direction in the drawing. The feedback mirror 55 converts the laser beam with circular polarization counter-clockwise toward the traveling direction into a laser beam with circular polarization clockwise toward the traveling direction.

The laser beam (with the circular polarization clockwise toward the traveling direction) reflected by the feedback mirror 55 passes through the self-oscillation light filter 53 again.

The laser beam (with circular polarization clockwise toward the traveling direction) passed through the self-oscillation light filter 53 again is reflected by the circular polarization mirror 56 to the left direction in the drawing. The circular polarization mirror 56 converts the laser beam with circular polarization (here, clockwise toward the traveling direction) into a laser beam with linear polarization (here, S-polarized) and reflects the converted laser beam.

The laser beam (S-polarized) reflected by the circular polarization mirror 56 is transmitted through a second window to be input into the discharge unit 52 again. The laser beam (S-polarized) input again into the discharge unit 52 is amplified again during passing through the excited laser medium.

The laser beam (S-polarized) amplified again in the discharge unit 52 is reflected by the polarizer 57 to the downward direction in the drawing.

The laser beam reflected by the polarizer 57 to the downward direction in the drawing is reflected by the mirror 110 to the right direction in the drawing to be input into the amplifier 45. The laser beam input into the amplifier 45 is amplified and input into the EUV light generation chamber

### (FIG. 1).

In this manner, the amplifier 45 for performing one-pass amplification may be provided in a stage following the amplifier 46 that performs two-pass amplification.

Note that, although the self-oscillation light filter 53 is disposed between the circular polarization mirror 56 and the feedback mirror 55 in the present embodiment as show in FIG. 21, the self-oscillation light filter 53 may be disposed between the discharge unit 52 and the circular polarization mirror 56, or between the polarizer 57 and the discharge unit 52. Alternatively, a plurality of self-oscillation light filters may be disposed at a plurality of positions selected out of a position between the circular polarization mirror 56 and the feedback mirror 55, a position between the discharge unit 52 and the circular polarization mirror 56, and a position between the polarizer 57 and the discharge unit 52.

Next, a driver laser according to a seventh embodiment of the present invention will be described.

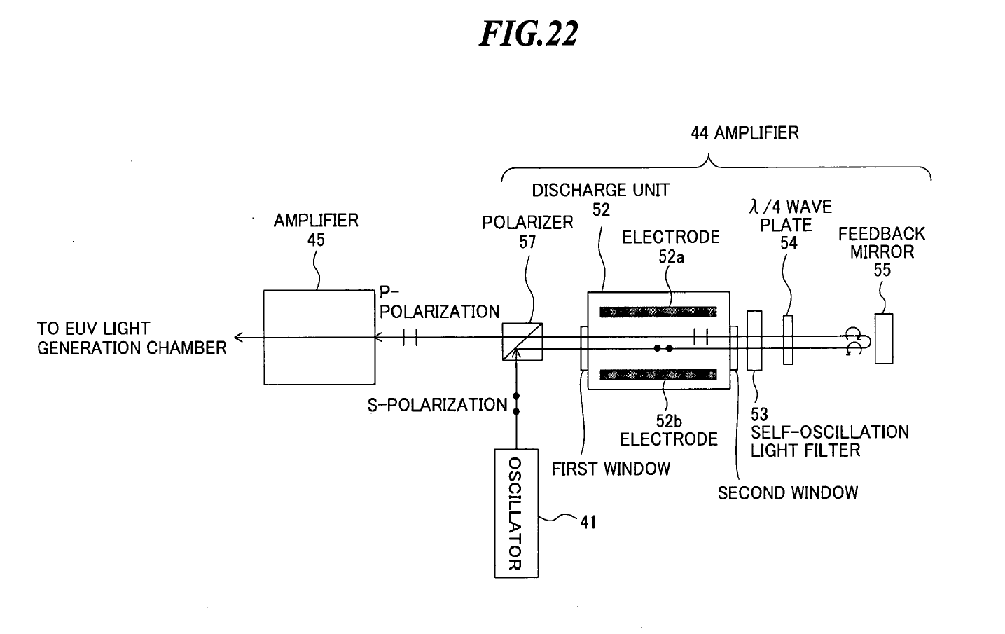

FIG. 22 is a schematic diagram showing a principle of a driver laser according to the seventh embodiment. As shown in FIG. 22, the driver laser includes an oscillator 41, an amplifier 44 for performing two-pass amplification, an amplifier 45 for performing one-pass amplification, and a mirror 110.

A laser beam (here, S-polarized) emitted from the oscillator 41 to the upward direction in the drawing is reflected by a polarizer 57 to the right direction in the drawing to be input into a discharge unit 52. The laser beam (S-polarized) reflected by the polarizer 57 and transmitted through a first window to be input into the discharge unit 52 is amplified during passing through an excited laser medium.

The laser beam (S-polarized) amplified in the discharge unit 52 is transmitted through a second window and passes through a self-oscillation light filter 53. When a self oscillation has occurred in the discharge unit 52 and self-oscillation light has been emitted to the side of the self-oscillation light filter 53, the self-oscillation light filter 53 attenuates the self-oscillation light.

The laser beam (S-polarized) passed through the self-oscillation light filter 53 passes through the λ/4 wave plate 54. The λ/4 wave plate 54 converts the laser beam with linear polarization (here, S-polarization) into a laser beam with circular polarization (here, counter-clockwise toward the traveling direction). The laser beam (with circular polarization counter-clockwise toward the traveling direction) passed through the λ/4 wave plate 54 is reflected by a feedback mirror 55. The feedback mirror 55 converts the laser beam with circular polarization counter-clockwise toward the traveling direction into a laser beam with circular polarization clockwise toward the traveling direction.

The laser beam (with circular polarization clockwise toward the traveling direction) reflected by the feedback mirror 55 passes through the λ/4 wave plate 54 again. The λ/4 wave plate 54 converts the laser beam with circular polarization (here, clockwise toward the traveling direction) into a laser beam with linear polarization (here, P-polarized).

The laser beam (P-polarized) passed through the λ/4 wave plate 54 passes through the self-oscillation light filter 53 again and is transmitted through a second window to be input into the discharge unit 52 again. The laser beam input again into the discharge unit 52 is amplified again during passing through the excited laser medium.

The laser beam (P-polarized) amplified again in the discharge unit 52 is transmitted through the first window and passes through the polarizer 57 to be input into the amplifier 45. The laser beam input into the amplifier 45 is amplified and input into the EUV light generation chamber (FIG. 1).

In this manner, the amplifier 45 that performs one-pass amplification may be further provided in a stage following the amplifier 46 that performs two-pass amplification.

Note that, although the self-oscillation light filter 53 is disposed between the discharge unit 52 and the λ/4 wave plate 54 in the present embodiment as shown in FIG. 22, the self-oscillation light filter 53 may be disposed between the λ/4 wave plate 54 and the feedback mirror 55, or between the polarizer 57 and the discharge unit 52. Alternatively, a plurality of self-oscillation light filters may be disposed at a plurality of positions selected out of a position between the discharge unit 52 and the λ/4 wave plate 54 (FIG. 22), a position between the λ/4 wave plate 54 and the feedback mirror 55, and a position between the polarizer 57 and the discharge unit 52.

Next, a driver laser according to an eighth embodiment of the present invention will be described.

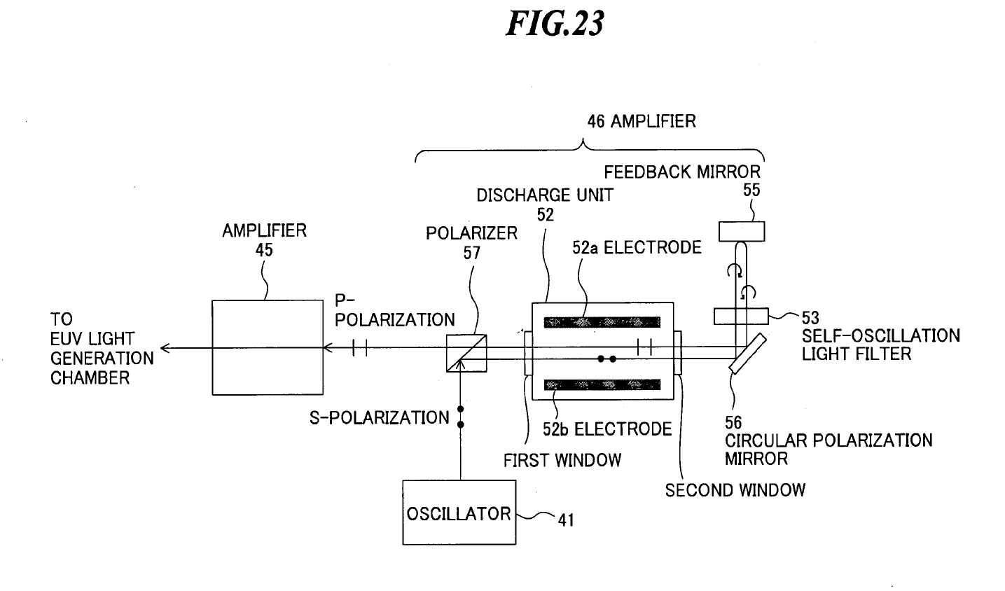

FIG. 23 is a schematic diagram showing a principle of a driver laser according to the eighth embodiment. As shown in FIG. 23, the driver laser includes an oscillator 41, an amplifier 46 for performing two-pass amplification, and an amplifier 45 for performing one-pass amplification. A laser beam (here, S-polarized) emitted from the oscillator 41 to the upward direction in the drawing is reflected by a polarizer 57 to the right direction in the drawing, and is transmitted through a first window to be input into the discharge unit 52. The laser beam (S-polarized) input into the discharge unit 52 is amplified during passing through an excited laser medium.

The laser beam (S-polarized) amplified in the discharge unit 52 is transmitted through a second window and reflected by a circular polarization mirror 56 to the upward direction in the drawing. The circular polarization mirror 56 converts the laser beam with linear polarization (S-polarization) amplified in the discharge unit 52 into a laser beam with circular polarization (here, clockwise toward the traveling direction) and reflects the converted laser beam.

The laser beam (with circular polarization clockwise toward the traveling direction) reflected by the circular polarization mirror 56 passes through a self-oscillation light filter 53. The self-oscillation light filter 53 attenuates self-oscillation light when a self oscillation has occurred in the discharge unit 52.

The laser beam (with circular polarization clockwise toward the traveling direction) passed through the self-oscillation light filter 53 is reflected by the feedback mirror 55 to the downward direction in the drawing. The feedback mirror 55 converts the laser beam with circular polarization clockwise toward the traveling direction into a laser beam with circular polarization counter-clockwise toward the traveling direction.

The laser beam (with circular polarization counter-clockwise toward the traveling direction) reflected by the feedback mirror 55 passes through the self-oscillation light filter 53 again.

The laser beam (with circular polarization counter-clockwise toward the traveling direction) passed through the self-oscillation light filter 53 again is reflected by the circular polarization mirror 56 to the left direction in the drawing. The circular polarization mirror 56 converts the laser beam with circular polarization (here, counter-clockwise toward the traveling direction) into a laser beam with linear polarization (here, P-polarization) and reflects the converted laser beam.

The laser beam (P-polarized) reflected by the circular polarization mirror 56 is transmitted through the second window to be input into the discharge unit 52 again. The laser beam (P-polarized) input again into the discharge unit 52 is amplified again during passing through the excited laser medium.

The laser beam (P-polarized) amplified again in the discharge unit 52 is transmitted through the first window and passes through the polarizer 57 to be input into the amplifier 45. The laser beam input into the amplifier 45 is amplified and input into the EUV light generation chamber (FIG. 1).

In this manner, the amplifier 45 that performs one-pass amplification may be provided in a stage following the amplifier 46 that performs two-pass amplification.

Note that, although the self-oscillation light filter 53 is disposed between the circular polarization mirror 56 and the feedback mirror 55 in the present embodiment as shown in FIG. 23, the self-oscillation light filter 53 may be disposed between the discharge unit 52 and the circular polarization mirror 56, or between the polarizer 57 and the discharge unit 52. Alternatively, a plurality of self-oscillation light filters may be disposed at a plurality of positions selected out of a position between the circular polarization mirror 56 and the feedback mirror 55, a position between the discharge unit 52 and the circular polarization mirror 56, and a position between the polarizer 57 and the discharge unit 52.

Next, a driver laser according to a ninth embodiment of the present invention will be described.

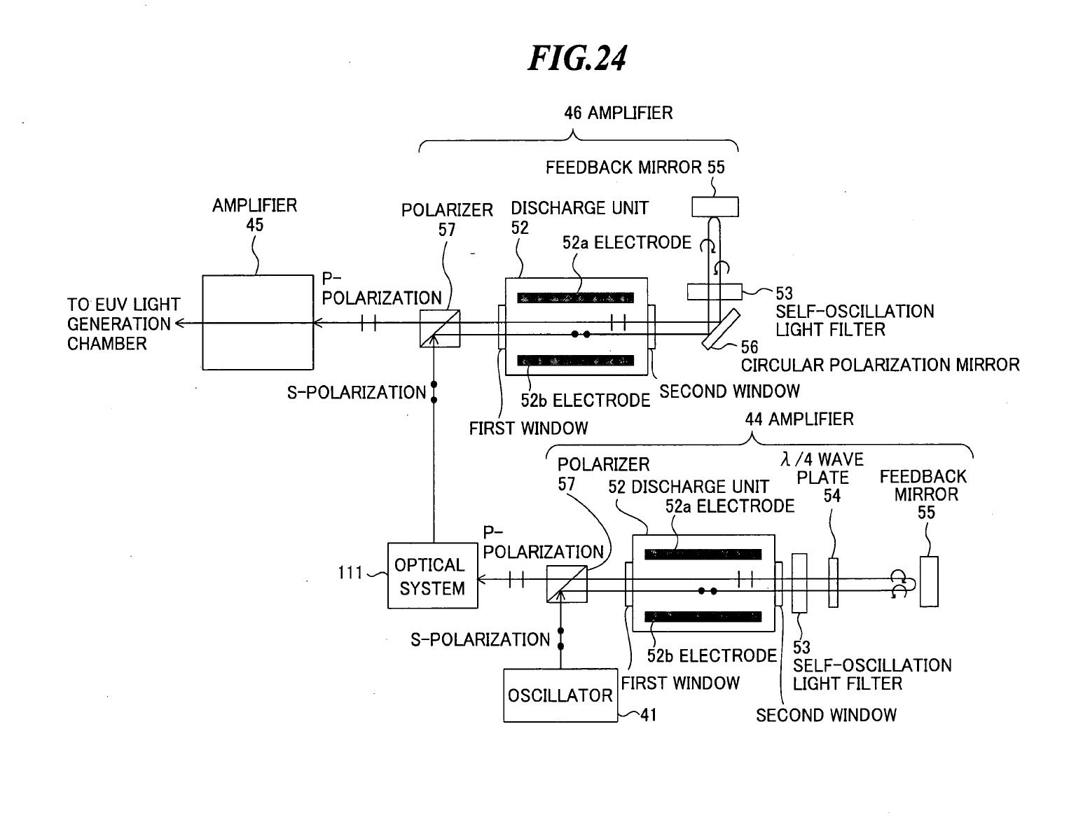

FIG. 24 is a schematic diagram showing a principle of a driver laser according to the ninth embodiment. As shown in FIG. 24, the driver laser includes an oscillator 41, amplifiers 44 to 46, and an optical system 111.

The amplifier 44 performs two-pass amplification for a laser beam (S-polarized) emitted from the oscillator 41, and outputs the amplified laser beam (P-polarized) to the optical system 111.

The optical system 111 converts the laser beam (P-polarized) input from the amplifier 44 into a laser beam with S polarization and leads the converted laser beam to the upward direction in the drawing.

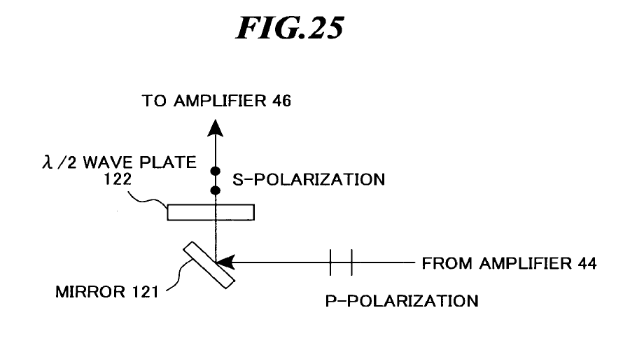

FIG. 25 is a schematic diagram showing the optical system 111. As shown in FIG. 25, this optical system 111 includes a mirror 121 and a λ/2 wave plate 122.

The laser beam (P-polarized) output from the amplifier 44 is reflected by the mirror 121 to the upward direction in the drawing and input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization and input into the amplifier 46.

Referring to FIG. 24 again, the amplifier 46 performs two-pass amplification for the laser beam (S-polarized) input from the optical system 111, and outputs the amplified laser beam (P-polarized) into the amplifier 45.

The amplifier 45 amplifies the laser beam (P-polarized) input from the amplifier 46 and outputs the amplified laser beam to the EUV light generation chamber (FIG. 1).

In this manner, there may be provided amplifiers that perform two-pass amplification in a multistage arrangement.

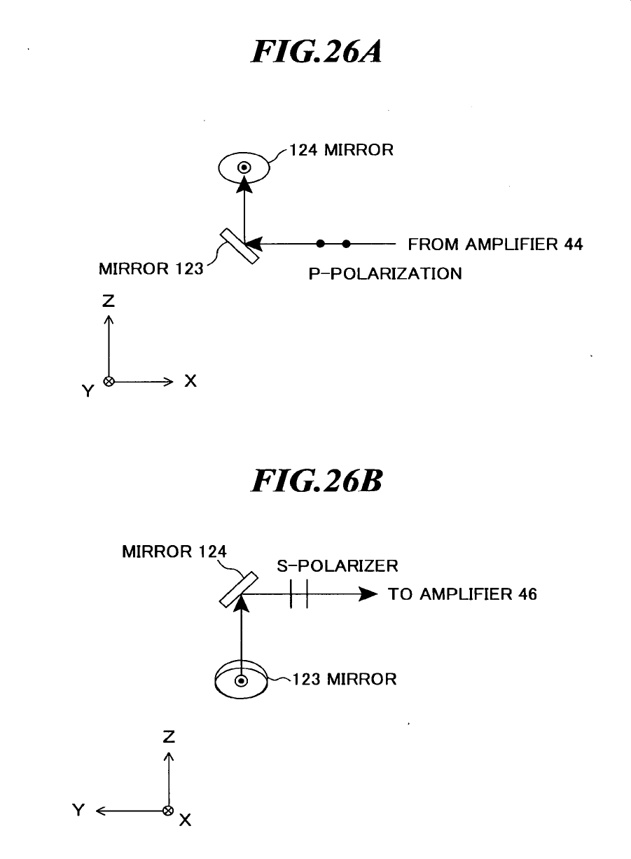

Note that, although the optical system 111 is constituted by the mirror 121 and the λ/2 wave plate 122 in the present embodiment as shown in FIG. 25, the optical system 111 may be constituted by two mirrors 123 and 124 as shown in FIGS. 26A and 26B.

As shown in FIGS. 26A and 26B, a laser beam (P-polarized) output from the amplifier 44 to a reverse X direction is reflected by the mirror 123 to the Z direction and further reflected by the mirror 124 to the reverse Y direction.

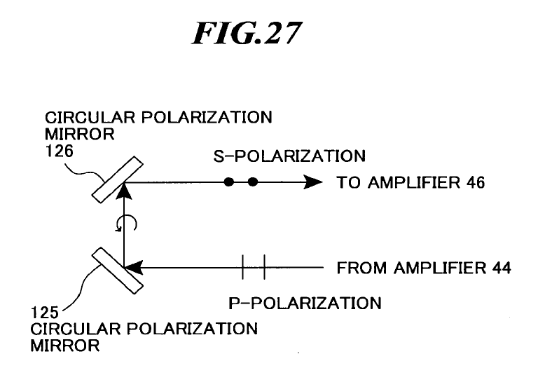

Also, the optical system 111 may be constituted by two circular polarization mirrors 125 and 126 as shown in FIG. 27.

As shown in FIG. 27, a laser beam (P-polarized) output from the amplifier 44 is converted by the circular polarization mirror 125 into a laser beam with circular polarization (circular polarization counter-clockwise toward the traveling direction) that is reflected to the upward direction in the drawing. The laser beam (with circular polarization counter-clockwise toward the traveling direction) reflected by the circular polarization mirror 125 to the upward direction in the drawing is converted by the circular polarization mirror 126 into a laser beam with S-polarization that is reflected to the right direction in the drawing.

Next, a driver laser according to a tenth embodiment of the present invention will be described.

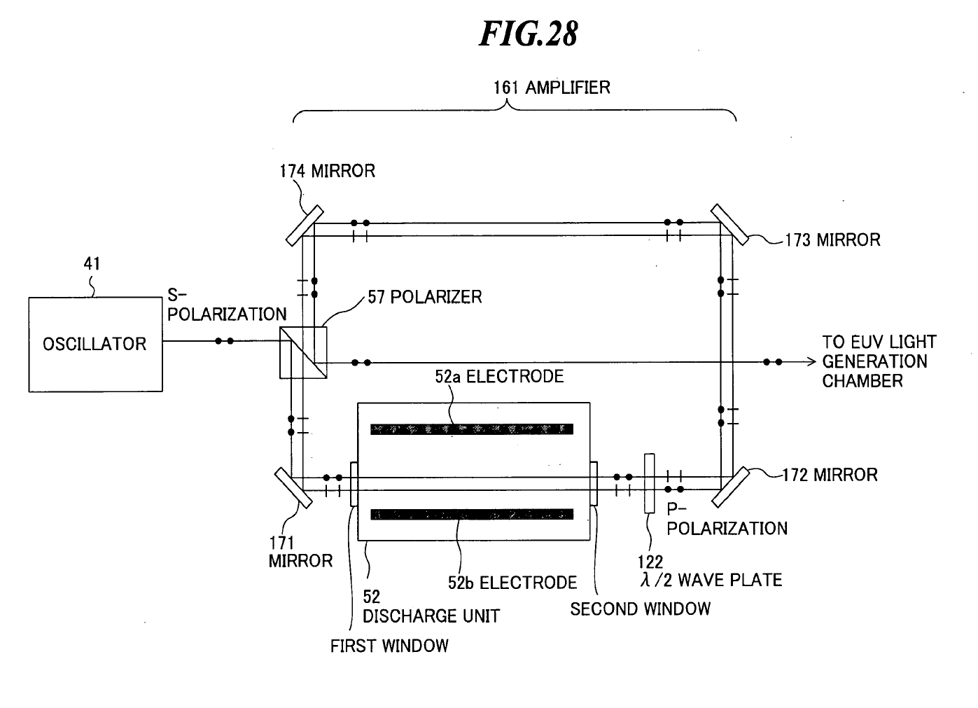

FIG. 28 is a schematic diagram showing a principle of a driver laser according to the tenth embodiment. As shown in FIG. 28, the driver laser includes an oscillator 41 and an amplifier 161. The amplifier 161 has a discharge unit 52, a polarizer 57, a λ/2 wave plate 122, and mirrors 171 to 174. Note that a constitution of the discharge unit 52 is similar to that of the discharge unit 52 in each of the first to the ninth embodiments described hereinabove (refer to FIG. 5 and FIG. 15), and the windows 131 and 132 shown in FIG. 5 and FIG. 15 correspond to first and second windows in the present embodiment.

The oscillator 41 emits a laser beam (here, S-polarized) to the polarizer 57. The laser beam (S-polarized) emitted from the oscillator 41 is reflected by the polarizer 57 to the downward direction in the drawing, further reflected by the mirror 171 to the right direction in the drawing, and transmitted through the first window to be input into the discharge unit 52. The laser beam (S-polarized) input into the discharge unit 52 is amplified during passing through an excited laser medium.

The laser beam (S-polarized) amplified in the discharge unit 52 is transmitted through the second window and input into the λ/2 wave plate 122. The λ/2 wave plate 122 rotates a polarization plane of light passing therethrough by 90°. That is, the laser beam with S-polarization input into the λ/2 wave plate 122 is converted into a laser beam with P-polarization.

The laser beam (P-polarized) passed through the λ/2 wave plate 122 is reflected by the mirror 172 to the upward direction in the drawing and further reflected by the mirror 173 to the left direction in the drawing. The laser beam (P-polarized) reflected by the mirror 173 is reflected by the mirror 174 to the downward direction in the drawing to be input into the polarizer 57.

The laser beam (P-polarized) input into the polarizer 57 passes through the polarizer 57, is reflected by the mirror 171 to the right direction in the drawing, and is transmitted through the first window to be input into the discharge unit 52 again. The laser beam (P-polarized) input again into the discharge unit 52 is amplified again during passing through the excited laser medium.

The laser beam (P-polarized) amplified again in the discharge unit 52 is transmitted through the second window to be input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization.

The laser beam (S-polarized) passed through the λ/2 wave plate 122 is reflected by the mirror 172 to the upward direction in the drawing, and further reflected by the mirror 173 to the left direction in the drawing. The laser beam (S-polarized) reflected by the mirror 173 is reflected by the mirror 174 to the downward direction in the drawing and input into the polarizer 57.

The laser beam (S-polarized) input into the polarizer 57 is reflected by the polarizer 57 to the direction of the EUV light generation chamber (FIG. 1) (the right direction in the drawing).

Note that, although the λ/2 wave plate 122 is used for conversions from S-polarization to P-polarization and from P-polarization to S-polarization in the present embodiment, other optical elements or optical systems may be used therefor. For example, instead of the λ/2 wave plate 122, the optical system 111 as shown in FIGS. 25 to 27 may be used.

Further, the self-oscillation light filter (refer to FIGS. 6, 12, and 13A, etc.) may be disposed further in a laser beam path.

Next, operation of the present embodiment will be described, compared with the first to ninth embodiments described hereinabove.

In the driver lasers according to the first to ninth embodiments, a laser beam output from the discharge unit 52 is input again into the discharge unit 52 by using the feedback mirror 55. Here, the feedback mirror 55 is basically disposed such that an optical reflection surface thereof is approximately perpendicular to an optical axis of the laser beam. However, the feedback mirror 55 disposed in such a manner may induce a self oscillation that causes ASE (amplified spontaneous emission) light, which is generated when a laser medium in the discharge unit 52 is in an excited state, to be resonated and be amplified, in the case where a gain (amplification degree) is high in the discharge unit 52.

On the other hand, the driver laser according to the present embodiment uses, as optical elements, a polarizer 57, the λ/2 wave plate 122, and mirrors 171 to 174, but does not use a feedback mirror. Among these optical elements, the polarizer 57 is disposed such that an optical plane thereof makes a predetermined angle against an optical axis of the laser beam and does not contribute to a self oscillation. Further, if the λ/2 wave plate 122, an optical plane of which can be tilted against an optical axis of the laser beam by about ±5°, is disposed at a position having a predetermined or farther distance form the discharge unit 52, a self oscillation phenomenon can be prevented. Therefore, in the driver laser according to the present embodiment, a self oscillation may be more difficult to occur than in driver lasers in the first to ninth embodiments.

Furthermore, when an optical system 111 as shown in FIGS. 25 to 27 is used in stead of the λ/2 wave plate 122, a self oscillation may be further more difficult to occur, since there is no optical element that is disposed perpendicular to an optical axis of the laser beam.

Next, a driver laser according to an eleventh embodiment of the present invention will be described.

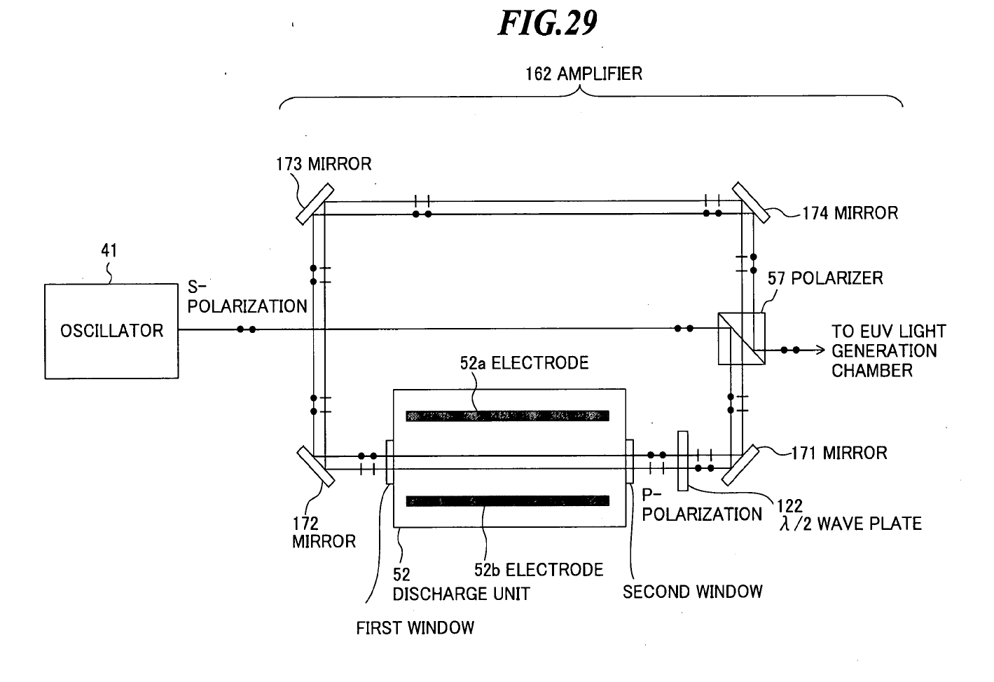

FIG. 29 is a schematic diagram showing a principle of a driver laser according to the eleventh embodiment. As shown in FIG. 29, the driver laser includes an oscillator 41 and an amplifier 162. The amplifier 162 has a discharge unit 52, a polarizer 57, a λ/2 wave plate 122, and mirrors 171 to 174.

The oscillator 41 (here, S-polarized) emits a laser beam to the polarizer 57. The laser beam (S-polarized) emitted from the oscillator 41 is reflected by the polarizer 57 to the downward direction in the drawing, further reflected by the mirror 171 to the left direction in the drawing, and input into the λ/2 wave plate 122. The λ/2 wave plate 122 rotates a polarization plane of light passing therethrough by 90°. That is, the laser beam with S-polarization input into the λ/2 wave plate 122 is converted into a laser beam with P-polarization.

The laser beam (P-polarized) passed through the λ/2 wave plate 122 is transmitted through a second window to be input into the discharge unit 52. The laser beam input into the discharge unit 52 is amplified during passing through an excited laser medium.

The laser beam (P-polarized) amplified in the discharge unit 52 is transmitted through a first window, reflected by the mirror 172 to the upward direction in the drawing, and further reflected by the mirror 173 to the right direction in the drawing. The laser beam (P-polarized) reflected by the mirror 173 is reflected by the mirror 174 to the downward direction in the drawing to be input into the polarizer 57.

The laser beam input into the polarizer 57 passes through the polarizer 57 and is reflected by the mirror 171 to the left direction in the drawing to be input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization.

The laser beam (S-polarized) passed through the λ/2 wave plate 122 is transmitted through the second window to be input again into the discharge unit 52. The laser beam (S-polarized) input again into the discharge unit 52 is amplified again during passing through the excited laser medium.

The laser beam (S-polarized) amplified again in the discharge unit 52 is transmitted through the first window, and is reflected by the mirror 172 to the upward direction in the drawing, and further reflected by the mirror 173 to the right direction in the drawing. The laser beam (S-polarized) reflected by the mirror 173 is reflected by the mirror 174 to the downward direction in the drawing to be input into the polarizer 57.

The laser beam (S-polarized) input into the polarizer 57 is reflected by the polarizer 57 to the direction of the EUV light generation chamber (FIG. 1) (the right direction in the drawing).

Note that, although the λ/2 wave plate 122 is used for conversions from S-polarization to P-polarization and from P-polarization to S-polarization in the present embodiment, other optical elements or optical systems may be used therefor. For example, instead of the λ/2 wave plate 122, the optical system 111 as shown in FIGS. 25 to 27 may be used.

Further, the self-oscillation light filter (refer to FIGS. 6, 12, and 13A, etc.) may be disposed further in a laser beam path.

Next, operation of the present embodiment will be described, compared with the tenth embodiment described hereinabove.

In the driver laser according to the tenth embodiment, the polarizer 57 is disposed on the left side within the amplifier 161 in the drawing (side of the oscillator 41) (refer to FIG. 28), and a distance between (i) a position, from which a laser beam is output toward following stage devices (an optical system or the like guiding the laser beam to such as the EUV light generation chamber, or other amplifiers), that is, a position of the polarizer 57 and (ii) the following devices is long. Further, a laser beam output from the polarizer 57 to the following stage devices crosses a laser beam that is reflected by the mirror 172 and travels to the mirror 173.

On the other hand, in the driver laser according to the present embodiment, the polarizer 57 is disposed on the right side within the amplifier 162 in the drawing (the side of the EUV light generation chamber), and a distance between (i) a position, from which a laser beam is output toward following stage devices, that is, a position of the polarizer 57 and (ii) the following stage devices becomes shorter. Thereby, it is easy to grasp a position, from which a laser beam is output, compared with the driver laser according to the tenth embodiment. Further, a laser beam output from the polarizer 57 to the following stage devices does not cross other laser beams. Therefore, it is easy to arrange a following stage light path for a laser beam output from the polarizer 57, compared with the driver laser according to the tenth embodiment.

Next, a driver laser according to a twelfth embodiment of the present invention will be described.

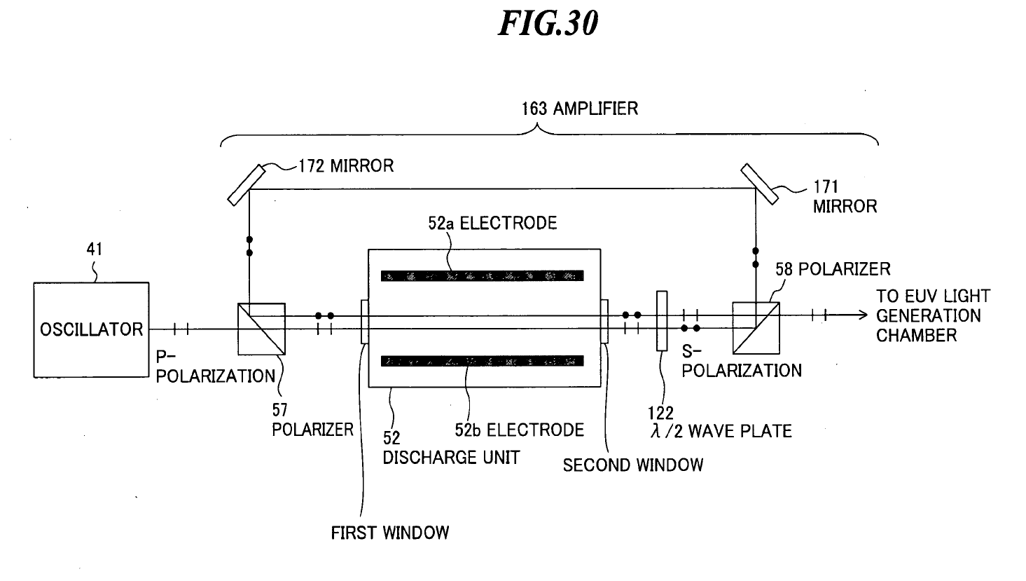

FIG. 30 is a schematic diagram showing a principle of a driver laser according to the twelfth embodiment. As shown in FIG. 30, the driver laser includes an oscillator 41 and an amplifier 163. The amplifier 163 has a discharge unit 52, polarizers 57 and 58, a λ/2 wave plate 122, and mirrors 171 and 172.

The oscillator 41 emits a laser beam (here, P-polarized) to the polarizer 57. The laser beam (P-polarized) emitted from the oscillator 41 passes through the polarizer 57 and is transmitted through a first window to be input into the discharge unit 52. The laser beam (P-polarized) input into the discharge unit 52 is amplified during passing through an excited laser medium.

The laser beam (P-polarized) amplified in the discharge unit 52 is transmitted through a second window and input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization.

The laser beam (S-polarized) passed through the λ/2 wave plate 122 is reflected by the polarizer 58 to the upward direction in the drawing, and further reflected by the mirror 171 to the left direction in the drawing. The laser beam (S-polarized) reflected by the mirror 171 is reflected by the mirror 172 to the downward direction in the drawing to be input into the polarizer 57.

The laser beam (S-polarized) input into the polarizer 57 is reflected by the polarizer 57 to the right direction in the drawing and is transmitted through the first window to be input into the discharge unit 52 again. The laser beam input again into the discharge unit 52 is amplified again during passing through the excited laser medium.

The laser beam (S-polarized) amplified again in the discharge unit 52 is transmitted through the second window to be input into the λ/2 wave plate 122. The λ/2 wave plate 122 rotates a polarization plane of light passing therethrough by 90°. That is, the laser beam with S-polarization input into the λ/2 wave plate 122 is converted into a laser beam with P-polarization.

The laser beam (P-polarized) passed through the λ/2 wave plate 122 passes through the polarizer 58 and is output to the side of the EUV light generation chamber.

Note that, although the λ/2 wave plate 122 is used for conversions from S-polarization to P-polarization and from P-polarization to S-polarization in the present embodiment, other optical elements or optical systems may be used therefor. For example, instead of the λ/2 wave plate 122, the optical system 111 as shown in FIGS. 25 to 27 may be used.

Further, the self-oscillation light filter (refer to FIGS. 6, 12, and 13A, etc.) may be disposed further in a laser beam path.

In the driver laser according to the present embodiment, the oscillator 41, the polarizer 57, the discharge unit 52, the λ/2 wave plate 122, and the polarizer 58 can be disposed on a straight line. Thereby, it is easy to grasp the optical path intuitively compared with the driver lasers according to the tenth and eleventh embodiments described hereinabove.

Further, through an optical path out of a straight line on which the oscillator 41, the polarizer 57, the discharge unit 52, the λ/2 wave plate 122, and the polarizer 58 is disposed, that is, through an optical path: the polarizer 58—the mirror 171—the mirror 172—the polarizer 57, a laser beam passes only one time. Thereby, compared with the driver lasers according to the tenth and eleventh embodiments, a risk that an operator is injured by putting a hand or the like into the optical path: the polarizer 58—the mirror 171—mirror 172—the polarizer 57, during adjusting the driver laser, can be minimized preferably for safety.

Next, a driver laser according to a thirteenth embodiment of the present invention will be described.

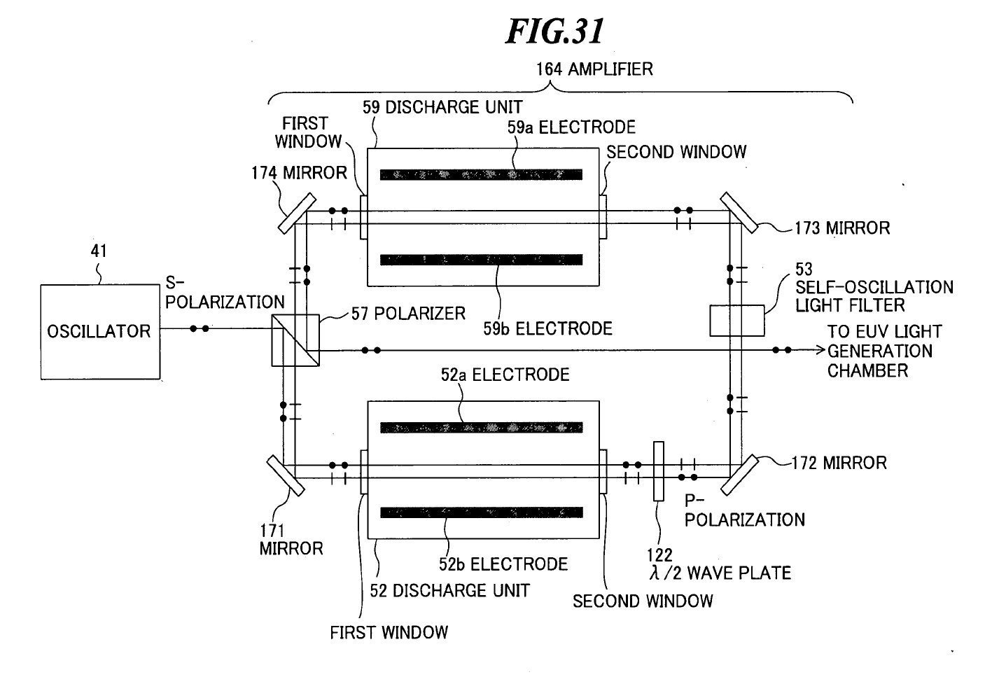

FIG. 31 is a schematic diagram showing a principle of a driver laser according to the thirteenth embodiment. As shown in FIG. 31, the driver laser includes an oscillator 41 and an amplifier 164. The amplifier 164 has discharge units 52 and 59, a self-oscillation light filter 53, a polarizer 57, a λ/2 wave plate 122, and mirrors 171 to 174. Note that a constitution of the discharge unit 59 is similar to that of the discharge unit 52 (FIGS. 5 and 15), and the windows 131 and 132 shown in FIGS. 5 and 15 correspond to first and second windows in the present embodiment.

The oscillator 41 emits a laser beam (here, S-polarized) to the polarizer 57. The laser beam (S-polarized) emitted from the oscillator 41 is reflected by the polarizer 57 to the downward direction in the drawing, further reflected by the mirror 171 to the right direction in the drawing and is transmitted through a first window to be input into the discharge unit 52. The laser beam (S-polarized) input into the discharge unit 52 is amplified during passing through an excited laser medium.

The laser beam (S-polarized) amplified in the discharge unit 52 is transmitted through a second window and input into the λ/2 wave plate 122. The λ/2 wave plate 122 rotates a polarization plane of light passing therethrough by 90°. That is, the laser beam with S-polarization input into the λ/2 wave plate 122 is converted into a laser beam with P-polarization.

The laser beam (P-polarized) passed through the λ/2 wave plate 122 is reflected by the mirror 172 to the upward direction in the drawing, and is input into the self-oscillation light filter 53. When a self oscillation has occurred in the discharge units 52 and 59, and self-oscillation light has been input into the self-oscillation light filter 53, the self-oscillation light filter 53 attenuates the self-oscillation light.

The laser beam (P-polarized) passed through the self-oscillation light filter 53 is reflected by the mirror 173 to the left direction in the drawing. The laser beam (P-polarized) reflected by the mirror 173 is transmitted through a second window to be input into the discharge unit 59. The laser beam (P-polarized) input into the discharge unit 59 is amplified during passing through an excited laser medium.

The laser beam (P-polarized) amplified in the discharge unit 59 is transmitted through a first window and reflected by the mirror 174 to the downward direction in the drawing to be input into the polarizer 57.

The laser beam (P-polarized) input into the polarizer 57 passes through the polarizer 57, is reflected by the mirror 171 to the right direction in the drawing, and transmitted through the first window to be input into the discharge unit 52 again. The laser beam (P-polarized) input again into the discharge unit 52 is amplified during passing through the excited laser medium.

The laser beam (P-polarized) amplified in the discharge unit 52 is transmitted through the second window and input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization.

The laser beam (S-polarized) passed through the λ/2 wave plate 122 is reflected by the mirror 172 to the upward direction in the drawing to be input into the self-oscillation light filter 53. When a self oscillation has occurred in the discharge units 52 and 59, and self-oscillation light has been input into the self-oscillation light filter 53, the self-oscillation light filter 53 attenuates the self-oscillation light.

The laser beam (S-polarized) passed through the self-oscillation light filter 53 is reflected by the mirror 173 to the left direction in the drawing. The laser beam (S-polarized) reflected by the mirror 173 is transmitted through the second window to be input into the discharge unit 59 again. The laser beam (S-polarized) input again into the discharge unit 59 is amplified during passing through the excited laser medium.

The laser beam (S-polarized) amplified in the discharge unit 59 is transmitted through the first window and reflected by the mirror 174 to the downward direction to be input into the polarizer 57.

The laser beam (S-polarized) input into the polarizer 57 is reflected by the polarizer 57 to the direction of the EUV light generation chamber (FIG. 1) (the right direction in the drawing).

The driver laser according to the present embodiment enables each of the two discharge units 52 and 59 to amplify a laser beam twice to obtain a high gain (amplification degree). Note that, in the case where a plurality of discharge units is used, it may occur that the plurality of discharge units is coupled optically and ASE light in each of the discharge units is amplified one another, resulting in a self oscillation. Therefore, it is preferable to provide a self-oscillation light filter on an optical path of a laser beam as shown in FIG. 31.

Next, a driver laser according to a fourteenth embodiment of the present invention will be described.

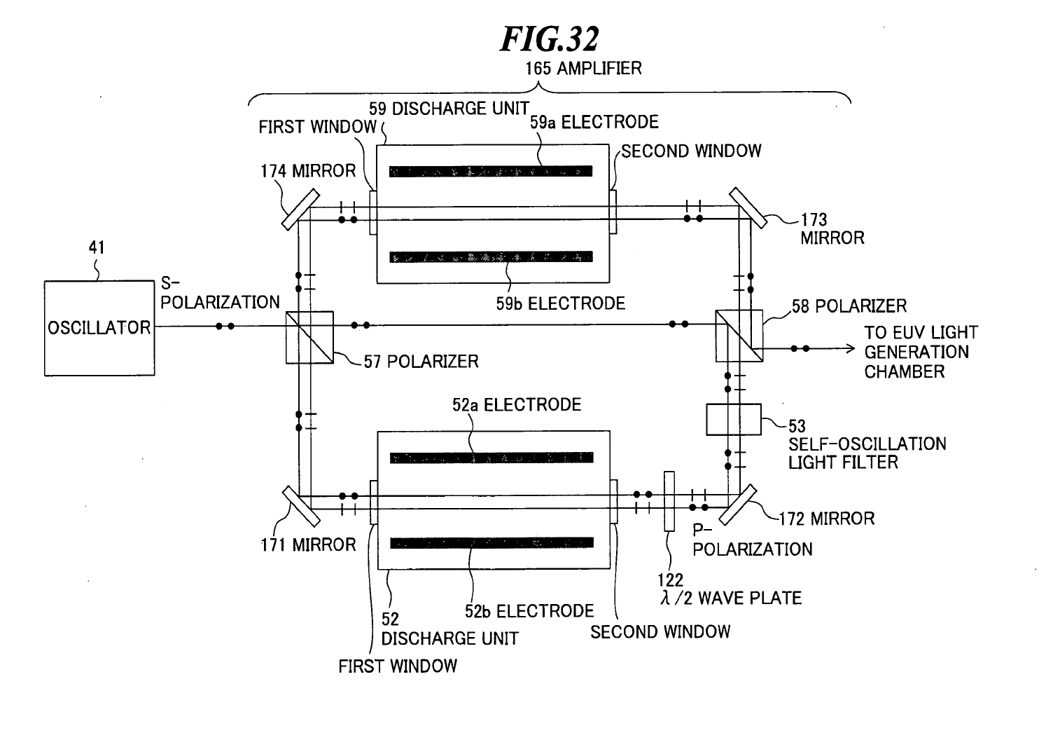

FIG. 32 is a schematic diagram showing a principle of a driver laser according to the fourteenth embodiment. As shown in FIG. 32, the driver laser includes an oscillator 41 and an amplifier 165. The amplifier 165 has discharge units 52 and 59, a self-oscillation light filter 53, polarizers 57 and 58, a λ/2 wave plate 122, and mirrors 171 to 174.

The oscillator 41 emits a laser beam (here, S-polarized) to the polarizer 57. The laser beam (S-polarized) emitted from the oscillator 41 is reflected by the polarizer 57 to the downward direction in the drawing, further reflected by the mirror 171 to the right direction in the drawing and is transmitted through a first window to be input into the discharge unit 52. The laser beam (S-polarized) input into the discharge unit 52 is amplified during passing through an excited laser medium.

The laser beam (S-polarized) amplified in the discharge unit 52 is transmitted through a second window and input into the λ/2 wave plate 122. The λ/2 wave plate 122 rotates a polarization plane of light passing therethrough by 90°. That is, the laser beam with S-polarization input into the λ/2 wave plate 122 is converted into a laser beam with P-polarization. The laser beam (P-polarized) passed through the λ/2 wave plate 122 is reflected by the mirror 172 to the upward direction in the drawing, and is input into the self-oscillation light filter 53. When a self oscillation has occurred in the discharge units 52 and 59, and self-oscillation light has been input into the self-oscillation light filter 53, the self-oscillation light filter 53 attenuates the self-oscillation light.

The laser beam (P-polarized) passed through the self-oscillation light filter 53 passes through the polarizer 58 and is reflected by the mirror 173 to the left direction in the drawing. The laser beam (P-polarized) reflected by the mirror 173 is transmitted through a second window to be input into the discharge unit 59. The laser beam (P-polarized) input into the discharge unit 59 is amplified during passing through an excited laser medium.

The laser beam (P-polarized) amplified in the discharge unit 59 is transmitted through a first window and reflected by the mirror 174 to the downward direction in the drawing to be input into the polarizer 57.

The laser beam (P-polarized) input into the polarizer 57 passes through the polarizer 57, is reflected by the mirror 171 to the right direction in the drawing, and is transmitted through the first window to be input into the discharge unit 52 again. The laser beam (P-polarized) input again into the discharge unit 52 is amplified during passing through the excited laser medium.

The laser beam (P-polarized) amplified in the discharge unit 52 is transmitted through the second window and input into the λ/2 wave plate 122. The λ/2 wave plate 122 rotates a polarization plane of light passing therethrough by 90°. That is, the laser beam with P-polarization input into the λ/2 wave plate 122 is converted into a laser beam with S-polarization.

The laser beam (S-polarized) passed through the λ/2 wave plate 122 is reflected by the mirror 172 to the upward direction in the drawing to be input into the self-oscillation light filter 53. When a self oscillation has occurred in the discharge units 52 and 59, and self-oscillation light has been input into the self-oscillation light filter 53, the self-oscillation light filter 53 attenuates the self-oscillation light.

The laser beam (S-polarized) passed through the self-oscillation light filter 53 is reflected by the polarizer 58 to the left direction in the drawing and input into the polarizer 57.

The laser beam (S-polarized) input into the polarizer 57 is reflected to the upward direction in the drawing and further reflected by the mirror 174 to the right direction in the drawing. The laser beam (S-polarized) reflected by the mirror 174 is transmitted through the first window to be input into the discharge unit 59. The laser beam (S-polarized) input into the discharge unit 59 is amplified during passing through the excited laser medium.

The laser beam (S-polarized) amplified in the discharge unit 59 is reflected by the mirror 173 to the downward direction in the drawing to be input into the polarizer 58.

The laser beam (S-polarized) input into the polarizer 58 is reflected by the polarizer 58 to the direction of the EUV light generation chamber (FIG. 1) (the right direction in the drawing).

As described hereinabove, in the case where a plurality of discharge units is used, it may occur that the plurality of discharge units is coupled optically and ASE light in each of the discharge units is amplified one another, resulting in a self oscillation. However, since a polarization direction of the ASE light is random, the energy of the ASE light can be minimized by limiting a laser beam polarization direction to a predetermined direction on an optical path between the discharge units. Therefore, in the diver laser according to the present embodiment, polarization purity of a laser beam propagating between the discharge unit 52 and the discharge unit 59 is improved by disposing the two polarizers 57 and 58 between the discharge unit 52 and the discharge unit 59, respectively. Thereby, a self oscillation caused by an optical coupling between the discharge unit 52 and the discharge unit 59 can be made difficult to occur. Note that the self-oscillation light filter 53 may be inserted on an optical path as shown in FIG. 32 in order to make a self oscillation more difficult to occur.

1-20. (canceled)

21. A driver laser for an extreme ultra violet light source device which generates extreme ultra violet light by irradiating a target material with a laser beam output from a laser light source to turn said target material into plasma, said driver laser comprising:
an oscillator for generating a laser beam by oscillation to output the generated laser beam; and
at least one amplifier for receiving the laser beam output from said oscillator and amplifying the laser beam to output the amplified laser beam, wherein said amplifier includes:
a discharge unit which amplifies the laser beam input into said discharge unit by using energy of a laser medium excited by discharge, and which outputs the amplified laser beam in a first direction;
a first optical system which leads the laser beam output from said discharge unit back to said discharge unit in a second direction opposite to the first direction, said first optical system including a circular polarization mirror and a feedback mirror, said circular polarization mirror having a reflection surface for reflecting the laser beam output from said discharge unit to said feedback mirror, said reflection surface of said circular polarization mirror being disposed at an angle other than perpendicular to the laser beam output in the first direction from said discharge unit, and said feedback mirror being arranged to reflect the laser beam reflected by said circular polarization mirror back to said circular polarization mirror such that the laser beam output from said discharge unit is returned to said discharge unit with a rotated polarization plane;
a second optical system which leads the laser beam output from said oscillator to said discharge unit in the first direction and leads the laser beam output from said discharge unit in a predetermined direction, said second optical system including a polarizer for reflecting the laser beam having a first polarization plane and transmitting the laser beam having a second polarization plane different from the first polarization plane; and
at least one self-oscillation light attenuation mechanism which attenuates self-oscillation light output from said discharge unit, said self-oscillation light attenuation mechanism being disposed on an optical path between said discharge unit and said feedback mirror.

22. A driver laser for an extreme ultra violet light source device which generates extreme ultra violet light by irradiating a target material with a laser beam output from a laser light source to turn said target material into plasma, said driver laser comprising:
an oscillator for generating a laser beam by oscillation to output the generated laser beam; and
at least one amplifier for receiving the laser beam output from said oscillator and amplifying the laser beam to output the amplified laser beam, wherein said amplifier includes:
a discharge unit which has a first window for inputting a laser beam and a second window for outputting a laser beam, and amplifies the laser beam input into said first window to output the amplified laser beam from said second window by using energy of a laser medium excited by discharge; and
an optical system which includes at least one optical element for rotating a polarization plane of the laser beam, at least one polarizer for reflecting the laser beam having a first polarization plane and transmitting the laser beam having a second polarization plane different from the first polarization plane, and a plurality of mirrors for reflecting the laser beam, and which leads the laser beam output from said oscillator to said first window of said discharge unit, then leads the laser beam output from said second window of said discharge unit to said first window of said discharge unit, and then leads the laser beam output from said second window of said discharge unit in a predetermined direction,
wherein each of said at least one polarizer and said plurality of mirrors has a reflection surface disposed at an angle other than perpendicular to the laser beam incident thereon so as to reflect the laser beam in a direction other than a direction opposite to an incident direction of the laser beam.

23. A driver laser for an extreme ultra violet light source device which generates extreme ultra violet light by irradiating a target material with a laser beam output from a laser light source to turn said target material into plasma, said driver laser comprising:
an oscillator for generating a laser beam by oscillation to output the generated laser beam; and
at least one amplifier for receiving the laser beam output from said oscillator and amplifying the laser beam to output the amplified laser beam, wherein said amplifier includes:
a first discharge unit and a second discharge unit, each of which has a first window and a second window for inputting and outputting a laser beam, and each of which amplifies the laser beam input into said first window to output the amplified laser beam from said second window and amplifies the laser beam input into said second window to output the amplified laser beam from said first window, by using energy of a laser medium excited by discharge; and
an optical system which includes at least one optical element for rotating a polarization plane of the laser beam, at least one polarizer for reflecting the laser beam having a first polarization plane and transmitting the laser beam having a second polarization plane different from the first polarization plane, and a plurality of mirrors for reflecting the laser beam, and which leads the laser beam output from said oscillator to said first window of said first discharge unit, then leads the laser beam output from said second window of said first discharge unit to said first window of said second discharge unit, then leads the laser beam output from said second window of said second discharge unit to said first window of said first discharge unit, then leads the laser beam output from said second window of said first discharge unit to one of said first window and said second window of said second discharge unit, and then leads the laser beam output from the other of said first window and said second window of said second discharge unit in a predetermined direction,
wherein each of said at least one polarizer and said plurality of mirrors has a reflection surface disposed at an angle other than perpendicular to the laser beam incident thereon so as to reflect the laser beam in a direction other than a direction opposite to an incident direction of the laser beam.

24. A driver laser for an extreme ultra violet light source device according to claim 22, wherein said amplifier further includes:
at least one self-oscillation light attenuation mechanism which attenuates self-oscillation light output from said first window and/or second window of said discharge unit.

25. A driver laser for an extreme ultra violet light source device according to claim 23, wherein said amplifier further includes:
at least one self-oscillation light attenuation mechanism which attenuates self-oscillation light output from said first window and/or second window of said first discharge unit and/or second discharge unit.

26. A driver laser for an extreme ultra violet light source device according to claim 21, wherein said self-oscillation light attenuation mechanism includes a cell which is filled with a saturable absorber and provided with two windows for inputting the laser beam into said saturable absorber and outputting the laser beam from said saturable absorber.

27. A driver laser for an extreme ultra violet light source device according to claim 24, wherein said self-oscillation light attenuation mechanism includes a cell which is filled with a saturable absorber and provided with two windows for inputting the laser beam into said saturable absorber and outputting the laser beam from said saturable absorber.

28. A driver laser for an extreme ultra violet light source device according to claim 25, wherein said self-oscillation light attenuation mechanism includes a cell which is filled with a saturable absorber and provided with two windows for inputting the laser beam into said saturable absorber and outputting the laser beam from said saturable absorber.

29. A driver laser for an extreme ultra violet light source device according to claim 26, wherein said two windows of said self-oscillation light attenuation mechanism are disposed so as to make a Brewster's angle against an optical axis of the laser beam.

30. A driver laser for an extreme ultra violet light source device according to claim 27, wherein said two windows of said self-oscillation light attenuation mechanism are disposed so as to make a Brewster's angle against an optical axis of the laser beam.

31. A driver laser for an extreme ultra violet light source device according to claim 28, wherein said two windows of said self-oscillation light attenuation mechanism are disposed so as to make a Brewster's angle against an optical axis of the laser beam.

32. A driver laser for an extreme ultra violet light source device according to claim 26, wherein said self-oscillation light attenuation mechanism further includes:
light collecting means for collecting the laser beam to input the collected laser beam into one of said two windows; and
collimating means for collimating a laser beam output from the other of said two windows.

33. A driver laser for an extreme ultra violet light source device according to claim 27, wherein said self-oscillation light attenuation mechanism further includes:
light collecting means for collecting the laser beam to input the collected laser beam into one of said two windows; and
collimating means for collimating a laser beam output from the other of said two windows.

34. A driver laser for an extreme ultra violet light source device according to claim 28, wherein said self-oscillation light attenuation mechanism further includes:
light collecting means for collecting the laser beam to input the collected laser beam into one of said two windows; and
collimating means for collimating a laser beam output from the other of said two windows.

35. A driver laser for an extreme ultra violet light source device according to claim 32, wherein said two windows of said self-oscillation light attenuation mechanism have diameters of pinholes such that said self-oscillation light attenuation mechanism has also a function of a pinhole plate.

36. A driver laser for an extreme ultra violet light source device according to claim 21, wherein said self-oscillation light attenuation mechanism includes:
a pinhole plate in which a pinhole is formed;
light collecting means for collecting the laser beam to said pinhole; and
collimating means for collimating the laser beam passed through said pinhole.

37. A driver laser for an extreme ultra violet light source device according to claim 21, wherein said oscillator and/or said amplifier includes CO₂ as the laser medium.

38. A driver laser for an extreme ultra violet light source device according to claim 21, wherein said oscillator and said at least one amplifier constitute at least one of a master oscillator power amplifier system and a master oscillator power oscillator system.

39. A driver laser for an extreme ultra violet light source device according to claim 22, wherein said oscillator and said at least one amplifier constitute at least one of a master oscillator power amplifier system and a master oscillator power oscillator system.

40. A driver laser for an extreme ultra violet light source device according to claim 23, wherein said oscillator and said at least one amplifier constitute at least one of a master oscillator power amplifier system and a master oscillator power oscillator system.
